(19) United States
(12) Patent Application Publication
(10) Pub. No.: US 2013/0197974 A1
(43) Pub. Date: Aug. 1, 2013

(54) SYSTEMS AND METHODS FOR BEVERAGE SALES AND MANAGEMENT

(71) Applicants: Brian Romanko, Austin, TX (US); Lee Brenner, Austin, TX (US); Joshua Hermsmeyer, Santa Rosa, CA (US); Michael Anthony Gunderloy, Newburgh, IN (US)

(72) Inventors: Brian Romanko, Austin, TX (US); Lee Brenner, Austin, TX (US); Joshua Hermsmeyer, Santa Rosa, CA (US); Michael Anthony Gunderloy, Newburgh, IN (US)

(73) Assignee: LABRADOR OMNIMEDIA, INC., Santa Rosa, CA (US)

(21) Appl. No.: 13/564,939

(22) Filed: Aug. 2, 2012

Related U.S. Application Data
(60) Provisional application No. 61/514,387, filed on Aug. 2, 2011.

(51) Int. Cl. G06Q 50/12

(52) U.S. Cl. CPC G06Q 50/12; G06Q 10/06315
USPC 705/7.33; 705/15; 705/7.29

(57) ABSTRACT

In one embodiment, a system is provided that includes a storage component configured to store first information pertaining to a plurality of beverages, the first information including, for each beverage, information assets associated with the beverage, and second information pertaining to a plurality of restaurants, the second information including, for each restaurant, a list of beverages from the plurality of beverages that are offered for sale by the restaurant. The system further includes a processor configured to transmit at least a portion of the first information and the second information to a plurality of handheld electronic devices used by customers at the plurality of restaurants, the transmitted portions enabling a customer dining at a restaurant to view, via the customer's handheld electronic device, the list of beverages offered for sale by the restaurant and the information assets associated with each beverage.

### CROSS REFERENCE TO RELATED APPLICATIONS

The present application claims the benefit and priority under 35 U.S.C. 119(e) of U.S. Provisional Application No. 61/514,387 entitled “INTEGRATED WINE SALE SYSTEM,” filed Aug. 2, 2011, the entire contents of which are incorporated herein by reference for all purposes.

### BACKGROUND

Generally speaking, existing beverage sales/management systems are fragmented rather than integrated across the beverage supply chain and thus provide poor visibility and control for the various players in the supply chain. For example, restaurant owners may implement point-of-sale (POS) systems that track beverage sales at individual restaurants (or groups of restaurants). However, since these systems are managed solely at the restaurant-level, other supply chain entities such as beverage wholesalers and beverage manufacturers cannot access the data in these systems to determine how well their beverages are selling through to customers (e.g., restaurant patrons) or gain insight into other sales-related information.

As another example, a beverage manufacturer may maintain, within an internal or third-party database, marketing information related to its beverages that would be well-suited for presentation to potential customers within a restaurant. However, since such databases are not linked to the various restaurants that sell the manufacturer's beverages, this type of marketing message delivery is not possible. Even if such marketing information could be made available to restaurants, existing systems lack the tools necessary to enable the delivery of that information to individual restaurant patrons at the time of dining, or to control how that information is delivered in a meaningful way.

Accordingly, it would be desirable to have improved beverage sales and management techniques that address the foregoing and other issues.

### SUMMARY

According to one embodiment, a system is provided that includes a storage component configured to store first information pertaining to a plurality of beverages, the first information including, for each beverage, information assets associated with the beverage, and second information pertaining to a plurality of restaurants, the second information including, for each restaurant, a list of beverages from the plurality of beverages that are offered for sale by the restaurant. The system further includes a processor configured to transmit at least a portion of the first information and the second information to a plurality of handheld electronic devices used by customers at the plurality of restaurants, the transmitted portions enabling a customer dining at a restaurant to view, via the customer's handheld electronic device, the list of beverages offered for sale by the restaurant and the information assets associated with each beverage.

In one embodiment, the storage component is further configured to store third information pertaining to a plurality of beverage manufacturers, where the processor is further configured to generate a first set of user interfaces accessible by the plurality of beverage manufacturers, the first set of user interfaces enabling each beverage manufacturer to manage a subset of the first information.

In one embodiment, the processor is further configured to generate a second set of user interfaces accessible by the plurality of restaurants for managing a subset of the second information.

In one embodiment, the storage component is further configured to store fourth information pertaining to data captured via the plurality of handheld electronic devices, the captured data including sales data and demographics data.

In one embodiment, the processor is further configured to generate a third set of user interfaces accessible by a plurality of beverage wholesalers, where the captured data is made available to the plurality of beverage manufacturers, the plurality of restaurants, and the plurality of beverage wholesalers via the first, second, and third sets of user interfaces respectively.

In one embodiment, the first set of user interfaces enables each beverage manufacturer to define a plurality of information asset groups for each beverage produced by the beverage manufacturer.

In one embodiment, the plurality of information asset groups includes a default group and one or more alternative groups.

In one embodiment, at least one information asset group is associated with a specific restaurant or set of restaurants.

In one embodiment, the first set of user interfaces further enables each beverage manufacturer to execute an A/B test for a beverage by selecting first and second information asset groups for the beverage; selecting a location for the A/B test, the location comprising one or more restaurants in the plurality of restaurants; and selecting a duration for the A/B test.

In one embodiment, executing the A/B test comprises providing the first information asset group to a first set of handheld electronic devices at the one or more restaurants, providing the second information asset group to a second set of handheld electronic device at the one or more restaurants, and collecting usage data from the first and second sets of handheld electronic devices.

In one embodiment, the second information further includes an inventory of beverages for at least one restaurant in the plurality of restaurants.

In one embodiment, at least one handheld electronic device in the plurality of handheld electronic devices is operable in an administrator mode, the administrator mode enabling a user of the at least one handheld electronic device to enter information for updating the inventory of beverages for the at least one restaurant.

In one embodiment, when operating in the administrator mode, the handheld electronic device is configured to present the inventory as an initial list of beverages, determine an order in which inventory information is entered by the user, and sort the initial list of beverages based on the determined order.

In one embodiment, each beverage in the inventory is associated with a par value.

In one embodiment, when operating in the administrator mode, the handheld electronic device is configured to generate a user interface identifying all beverages in the inventory whose stock count is at or below the beverage's associated par value.

In one embodiment, a subset of the first information is retrieved from a third-party beverage directory.

In one embodiment, the storage component is further configured to store third information comprising, for each handheld electronic device in the plurality of handheld electronic devices, a unique identifier identifying the handheld electronic device and an association between the unique identifier and a restaurant identifier, the association identifying a restaurant in the plurality of restaurants where the handheld electronic device is currently deployed.

In one embodiment, the plurality of beverages includes wines, spirits, or beers.

According to another embodiment, a method is provided that includes storing, by a computer system, first information pertaining to a plurality of beverages, the first information including, for each beverage, information assets associated with the beverage, and storing, by the computer system, second information pertaining to a plurality of restaurants, the second information including, for each restaurant, a list of beverages from the plurality of beverages that are offered for sale by the restaurant. The method further includes transmitting, by the computer system, at least a portion of the first information and the second information to a plurality of handheld electronic devices used by customers at the plurality of restaurants, the transmitted portions enabling a customer dining at a restaurant to view, via the customer's handheld electronic device, the list of beverages offered for sale by the restaurant and the information assets associated with each beverage.

According to another embodiment, a non-transitory computer readable storage medium having stored thereon program code executable by a processor is provided. The program code comprises code that causes the processor to store first information pertaining to a plurality of beverages, the first information including, for each beverage, information assets associated with the beverage; code that causes the processor to store second information pertaining to a plurality of restaurants, the second information including, for each restaurant, a list of beverages from the plurality of beverages that are offered for sale by the restaurant; and code that causes the processor to transmit at least a portion of the first information and at least a portion of the second information to a plurality of handheld electronic devices used by customers at the plurality of restaurants, the transmitted portions enabling a customer dining at a restaurant to view, via the customer's handheld electronic device, the list of beverages offered for sale by the restaurant and the information assets associated with each beverage.

A further understanding of the nature and advantages of the embodiments disclosed herein can be realized by reference to the remaining portions of the specification and the attached drawings.

### BRIEF DESCRIPTION OF THE DRAWINGS

FIG. 1 is a simplified block diagram of a system environment in accordance with an embodiment of the present invention.

FIG. 2 is a simplified block diagram of a computer system in accordance with an embodiment of the present invention.

FIGS. 3A and 3B are flow diagrams of processes for defining and editing information assets for a beverage in accordance with an embodiment of the present invention.

FIG. 4 is an example user interface for entering information assets in accordance with an embodiment of the present invention.

FIG. 5 is a simplified block diagram illustrating multiple information asset groups for a beverage in accordance with an embodiment of the present invention.

FIG. 6 is a flow diagram of a process for defining restaurant-level information for a beverage in accordance with an embodiment of the present invention.

FIG. 7A is a flow diagram of a process for configuring a handheld electronic device for initial use in a restaurant in accordance with an embodiment of the present invention.

FIG. 7B is a flow diagram of a process for presenting beverage information via a handheld electronic device in accordance with an embodiment of the present invention.

FIGS. 8A and 8B are example user interfaces that can be displayed on a handheld electronic device for presenting beverage information to a customer in accordance with an embodiment of the present invention.

FIG. 9 is a flow diagram of a process for carrying out an A/B test for a beverage in accordance with an embodiment of the present invention.

FIG. 10 is an example user interface for defining an A/B test for a beverage in accordance with an embodiment of the present invention.

FIG. 11 is a flow diagram of a process for carrying out a beverage inventory count in accordance with an embodiment of the present invention.

FIGS. 12A-12C are example user interfaces that can be displayed on a handheld electronic device for facilitating inventory management in accordance with an embodiment of the present invention.

FIGS. 13A-13K are example user interfaces that can be displayed via a restaurant dashboard for facilitating inventory management in accordance with an embodiment of the present invention.

FIG. 14 is a flow diagram for incrementally syncing information between a server and a handheld electronic device in accordance with an embodiment of the present invention.

### DETAILED DESCRIPTION

Embodiments of the present invention provide systems and methods for beverage sales and management. In the following description, for purposes of explanation, numerous examples and details are set forth in order to provide an understanding of specific embodiments. It will be evident, however, to one skilled in the art that certain embodiments can be practiced without some of these details, or can be practiced with modifications or equivalents thereof. For instance, several of the described examples and embodiments pertain specifically to the sales and management of wines. However, it should be appreciated that the techniques described herein are equally applicable other types of beverages (both alcoholic and non-alcoholic) such as beer, spirits, soft drinks, and so on.

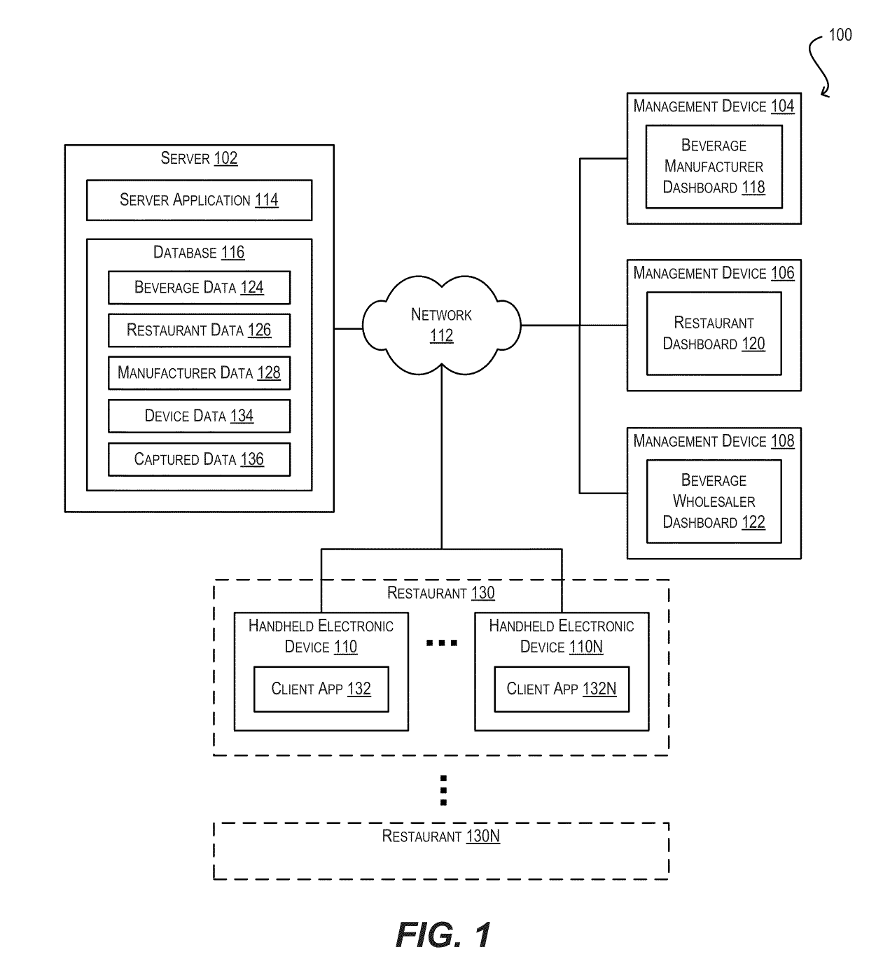

FIG. 1 is a simplified block diagram of a system environment 100 according to an embodiment of the present invention. System environment 100 includes a server 102 that is communicatively coupled with a number of client devices (e g , management devices 104, 106, and 108 and handheld electronic devices 110-110N) via a network 112. Server 102 can be implemented using a computer system (or cluster/farm of computer systems) that is designed to serve content to a large number of clients, such as a rack-mount server, a blade server, or the like. Management devices 104, 106, and 108 can be implemented using any type of end-user computing device, such as a personal desktop computer, a laptop computer, a tablet device, a smartphone, a digital media receiver, or the like. And handheld electronic devices 110-110N can be implemented using any type of computing device that is portable in nature, such as a tablet device, a personal digital assistant (PDA), a smartphone, or the like.

As shown in FIG. 1, server 102 is configured to host a server application 114 and a database 116. Server application 114 can interact with database 116, management devices 104, 106, and 108, and handheld electronic devices 110-110N to facilitate the various beverage sales/management techniques of the present invention. For example, server application 114 can generate a number of user interface sets, or “dashboards” (e.g., 118, 120, and 122), for presentation on management devices 104, 106, and 108. In one embodiment, dashboards 118, 120, and 122 can be generated as web pages that are rendered in a web browser of management devices 104, 106, and 108 respectively. These dashboards can enable various participants in a typical beverage supply chain (e.g., beverage manufacturers, restaurants, and beverage wholesalers) to enter information into, and access information from, server application 114 regarding the beverages they produce or sell.

For instance, beverage manufacturer dashboard 118 can enable beverage manufacturers to enter, for each beverage they create, information assets that may be of interest to potential customers. Examples of such information assets can include beverage descriptions (e.g., flavor profile, where/how the beverage was made, food pairings, etc.), related multimedia items (e.g., pictures, videos, etc.), technical details, ratings, and so on. These information assets can be organized into “information asset groups” (described in further detail below) and stored as beverage data 124 in database 116.

Further, restaurant dashboard 120 can enable restaurants to enter information regarding the beverages they offer for sale on-premise. This information can include, e.g., beverage name, beverage price, whether the beverage is offered by the glass and/or bottle, and so on. In certain embodiments, restaurant dashboard 120 can also enable restaurants to modify, remove, or add to any of the information assets specified for a beverage via beverage manufacturer dashboard 118. Once entered, this restaurant-level beverage information can be stored as restaurant data 126 in database 116.

Yet further, beverage wholesaler dashboard 122 can enable beverage wholesalers to track/view information regarding the manufacturers and the restaurants they do business with (stored as manufacturer data 128 and restaurant data 126 in database 116), as well as review sales data and other statistics pertaining to the beverages they purchase and distribute/re-sell.

Once beverage manufacturers and restaurants have provided beverage data 124 and restaurant data 126 via dashboards 118 and 120, server application 114 can synchronize this data with handheld electronic devices 110-110N that are deployed at various restaurants 130-130N. In particular, server application 114 can transmit beverage data 124 and restaurant data 126 to client applications 132-132N (e.g., iOS™ or Android™ applications) running on devices 110-110N that are specifically configured to interact with server application 114. For security purposes, server application 114 can keep track of which handheld electronic devices are authorized to receive data from application 114 via device data 134 stored in database 116.

Handheld electronic devices 110-110N can then be used to present, via client applications 132-132N, a list of available beverages and related information assets in an electronic format to patrons in restaurants 130-130N. For instance, at the time of dining, a restaurant patron can be provided a handheld electronic device 110 and given the opportunity to view/interact with the beverage list and the information assets for each beverage via client application 132. Once the restaurant patron has finished using handheld electronic device 110, information regarding the patron's interaction with the device (including, e.g., the beverage(s) the patron has purchased) can be captured and transmitted to server application 114 for storage in database 116 (as captured data 136) and for subsequent reporting/analysis.

With system environment 100, each of the participants in the beverage supply chain can benefit significantly. For example, restaurants can provide their patrons with an attractive and engaging electronic beverage list that includes up-to-date and detailed information about each beverage. As a result, the restaurant patrons can learn and discover more about the offered beverages than they possibly could from a traditional printed list, and thus may be more inclined to try a new, previously unfamiliar beverage (e.g., a new wine).

As another example, by supplying all or part of the information assets that are presented via handheld electronic devices 110-110N, beverage manufacturers can deliver a marketing message directly to their customers (i.e., the restaurant patrons). In certain embodiments, beverage manufacturers can fine-tune and test their marketing messages though beverage manufacturer dashboard 118 by, e.g., assigning different groups of information assets for a beverage by restaurant, region, etc., or by specifying an A/B testing scenario for a beverage in a particular restaurant or set of restaurants.

As yet another example, beverage manufacturers, beverage wholesalers, and restaurants can obtain, from server application 114 via dashboards 118, 120, and 122, detailed data regarding beverage sales organized by various criteria such as restaurant, region, customer demographics, beverage type, price point, and more. In the past, beverages sales were largely a “black box;” beverage wholesalers purchased quantities of beverages from beverage manufacturers and then re-sold those quantities to restaurants, but neither the wholesalers nor the manufacturers had any insight into how well a particular beverage was selling through to customers until re-orders were received from the restaurants. With embodiments of the present invention, all players can see the current state of sales for a particular beverage as well as related analytic data.

In addition to the foregoing, certain techniques described herein enable restaurants 130-130N to more easily manage their “hard” (i.e., physical) beverage inventory (e.g., number of wine bottles in the wine cellar/storage area). In particular, restaurants 130-130N can operate client applications 132-132N in an “administrator” mode and enter beverage inventory levels directly into devices 110-110N. With this feature, restaurants 130-130N can more precisely track their hard inventory levels than with previous “pen and paper” methods, and can also automate certain inventory tasks, such as beverage re-ordering. Thus, restaurants 130-130N can avoid situations where patrons are unpleasantly surprised by the lack of availability of a particular beverage.

These and other features of the present invention are described in further detail in the sections that follow.

It should be appreciated that system environment 100 is illustrative and is not intended to limit embodiments of the present invention. For example, although database 116 is shown as being hosted by server 102, one of ordinary skill the art will appreciate that database 116 can be resident on a separate physical machine. Further, while dashboards 118, 120, and 122 are shown as being presented on management devices 104, 106, and 108 respectively, these dashboards can also be accessible on other devices such as handheld electronic devices 110-110N. Yet further, the various entities depicted in system environment 100 can have other capabilities or include other components that are not specifically described. One of ordinary skill in the art will recognize many variations, modifications, and alternatives.

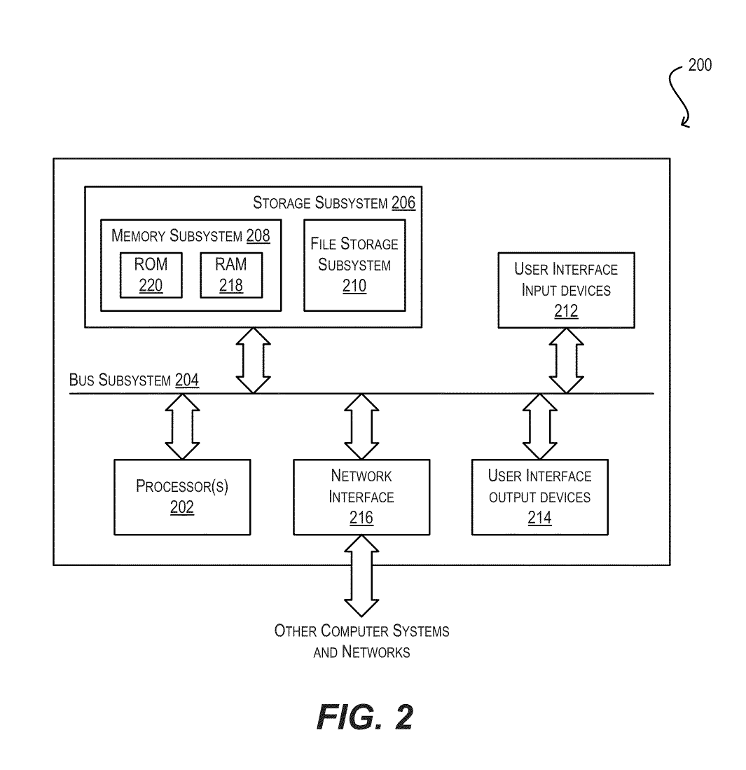

FIG. 2 is a simplified block diagram of a computer system 200 according to an embodiment of the present invention. Computer system 200 can be used to implement any of the computing devices/systems described with respect to FIG. 1, such as server 102, management devices 104-108, and handheld electronic devices 110-110N. As shown in FIG. 2, computer system 200 includes one or more processors 202 that communicate with a number of peripheral devices via a bus subsystem 204. These peripheral devices include a storage subsystem 206 (comprising a memory subsystem 208 and a file storage subsystem 210), user interface input devices 212, user interface output devices 214, and a network interface subsystem 216.

Bus subsystem 204 can provide a mechanism for letting the various components and subsystems of computer system 200 communicate with each other as intended. Although bus subsystem 204 is shown schematically as a single bus, alternative embodiments of the bus subsystem can utilize multiple busses.

Network interface subsystem 216 can serve as an interface for communicating data between computer system 200 and other computer systems or networks. Embodiments of network interface subsystem 216 can include, e.g., an Ethernet card, a Wi-Fi and/or cellular adapter, a modem (telephone, satellite, cable, ISDN, etc.), digital subscriber line (DSL) units, and/or the like.

User interface input devices 212 can include a keyboard, pointing devices (e.g., mouse, trackball, touchpad, etc.), a scanner, a barcode scanner, a touch-screen incorporated into a display, audio input devices (e.g., voice recognition systems, microphones, etc.) and other types of input devices. In general, use of the term “input device” is intended to include all possible types of devices and mechanisms for inputting information into computer system 200.

User interface output devices 214 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 200.

Storage subsystem 206 includes a memory subsystem 208 and a file/disk storage subsystem 210. Subsystems 208 and 210 represent non-transitory computer-readable storage media that can store program code and/or data that provide the functionality of embodiments of the present invention.

Memory subsystem 208 includes a number of memories including a main random access memory (RAM) 218 for storage of instructions and data during program execution and a read-only memory (ROM) 220 in which fixed instructions are stored. File storage subsystem 210 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 200 is illustrative and not intended to limit embodiments of the present invention. Many other configurations having more or fewer components than system 200 are possible.

### Information Asset Entry—Beverage Manufacturer Level

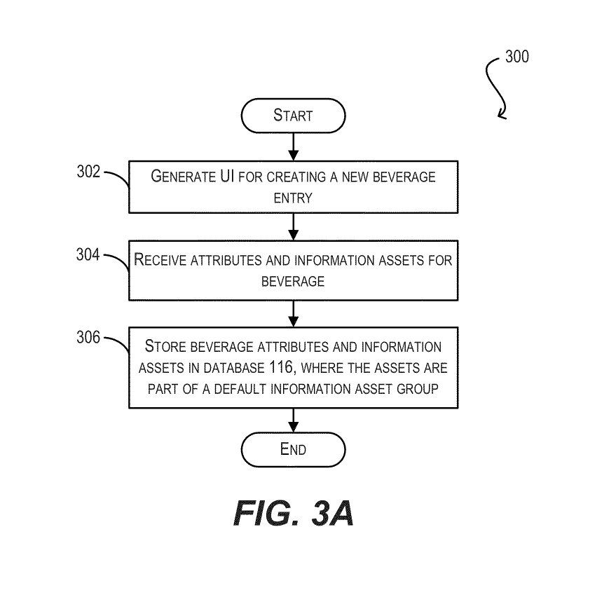

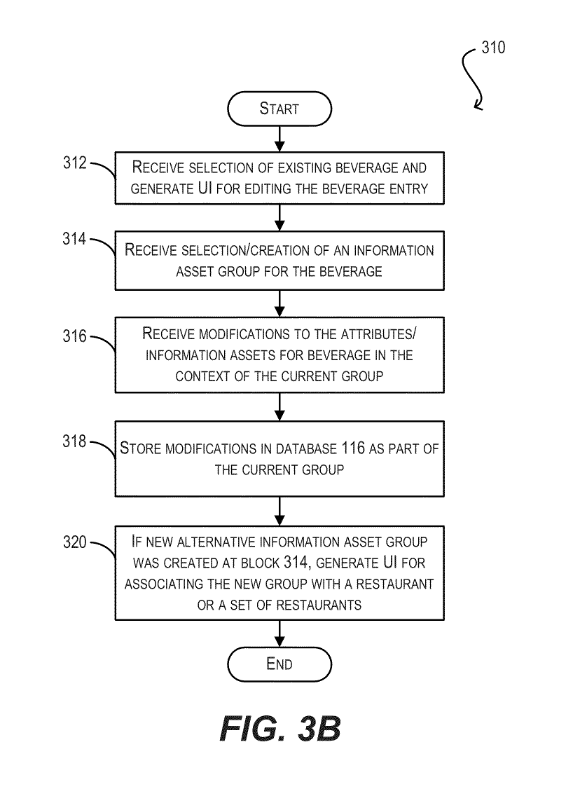

As described with respect to FIG. 1, beverage manufacturers can initially provide, via beverage manufacturer dashboard 118, information assets to server application 114 pertaining to the beverages they produce. FIG. 3A illustrates a process 300 that can be performed by server application 114 for receiving information assets via beverage manufacturer dashboard 118 for a new beverage according to an embodiment of the present invention.

At block 302, server application 114 can generate a user interface within beverage manufacturer dashboard 118 that allows a user (e.g., a beverage manufacturer representative) to create a database entry for a new beverage (i.e., a beverage that has not been previously stored in beverage data 124 of database 116) and enter one or more associated attributes and information assets. At block 304, server application 114 can receive the attributes and the information assets from the user. For a typical wine, the attributes and information assets received at block 304 can include, e.g.:
1. Full wine name (e.g., winery name, varietal or blend, vintage (year), vineyard name)
2. Picture of the wine label
3. Additional pictures (e.g., vineyard, winery, staff, etc.)
4. Description (e.g., flavor profile, how it was made, the vineyard, etc.)
5. Technical details (e.g., percent alcohol, pH, total acidity, Brix, etc.)
6. Video clips (perhaps 20-30 seconds with closed captioning)
7. Geographic location to locate vineyard or winery on a map

In one embodiment, the full wine name can include both required and optional components. For instance, the required components can include winery name, varietal or blend, and vintage (or specification of “NV” (non-vintage)). The optional components can include, e.g., vineyard designation, estate, and reserve.

At block 306, the beverage attributes and information assets received at block 304 can be stored in beverage data 124 of database 116. Further, in a particular embodiment, the information assets can be marked as a “default” information asset group. In other words, the information assets entered at block 304 can be considered default information assets for the beverage, such that the information assets are available to all restaurants that add the beverage to their available beverage list. This allows a beverage manufacturer to streamline the delivery of the information assets, since the beverage manufacturer does not need to manually associate the information assets with each individual restaurant.

In some embodiments, the information assets for the beverage may already reside in an external data source. For example, the beverage manufacturer may have previously uploaded beverage information assets to a third-party beverage directory or aggregator. In these embodiments, the user can simply provide a pointer (e.g., name, uniform resource locator (URL), etc.) to the external data source, rather than manually entering beverage attributes and information assets at block 304. Server application 114 can then use the pointer to download attributes and assets for the beverage from the external data source. For instance, if the external data source is web-based, server application 114 can use one or more web services APIs to download the appropriate data. In one embodiment, server application 114 can automatically refresh the downloaded data on a periodic basis to ensure that beverage data 124 remains in sync with the external data source.

Once the attributes and information assets for a new beverage have been stored in database 116 per process 300 of FIG. 3A, the beverage manufacturer can use beverage manufacturer dashboard 118 to modify (e.g., add, remove, or modify) the attributes and/or assets of the beverage as needed. FIG. 3B illustrates a process 310 that can be performed by server application 114 for carrying out this type of modification according to an embodiment of the present invention. In certain embodiments, any modifications that are performed per process 310 can be automatically communicated to affected restaurants (i.e., restaurants that have added the beverage to their beverage list and have access/visibility to the modified attributes/assets) so that the restaurants can update their beverage lists accordingly.

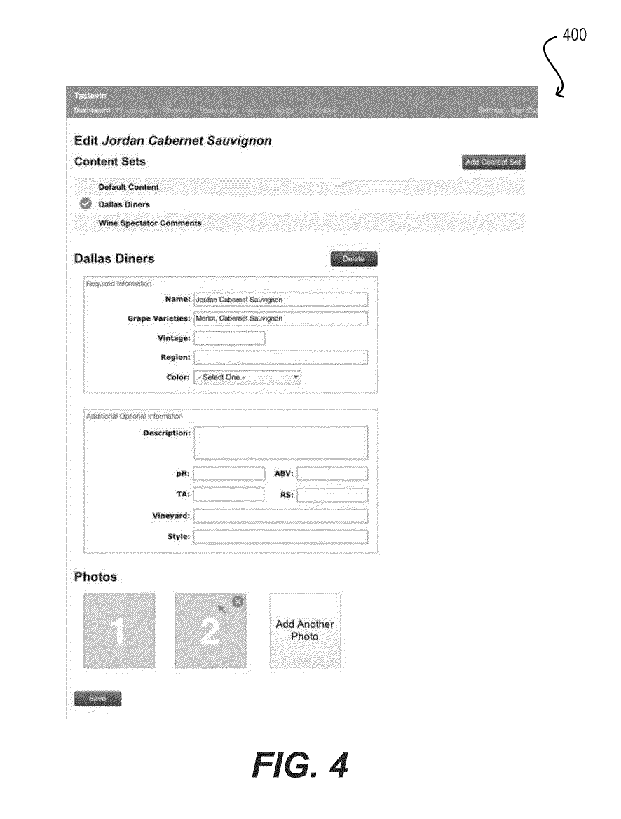

At block 312, server application can receive, from a user of beverage manufacturer dashboard 118, a selection of an existing beverage in beverage data 124 of database 116. For instance, the user may provide a query that identifies the beverage by name using one or more required or optional elements. Server application 114 can then retrieve the entry for the beverage from database 116 and generate an “edit” user interface for editing the beverage's attributes and information assets. An example of such an edit user interface for a wine named “Jordan Cabernet Sauvignon” is shown in FIG. 4 as user interface 400.

At block 314, server application 114 can receive, from the user, a selection of (or a command to create) an information asset group for the beverage. As noted with respect to FIG. 3A, when a beverage entry is first created, the attributes and information assets for the beverage can be stored in a default information asset group that is available to all restaurants. However, in some situations, a beverage manufacturer may want to define one or more alternative information assets for a beverage that are different from the default information assets. For example, the beverage manufacturer may want to change the textual description or the photos associated with the beverage for restaurants in a particular city or region. As another example, the beverage manufacturer may want to tailor certain information assets to a specific restaurant, for example, by presenting a video clip talking about what items on the restaurant's menu are best paired with the beverage. As yet another example, the beverage manufacturer may want to set up two distinct information asset groups for the purpose of A/B testing at a particular restaurant or set of restaurants (described in further detail below).

Thus, at block 314, the user can create a new alternative information asset group for the beverage, or select an existing information asset group. When creating a new alternative information asset group, the user can provide a name for the group so that it is readily distinguishable from other groups for the same beverage. If the user simply wants to edit the attributes/information assets for the default information asset group, the user can select the default group at block 314. In the example of FIG. 4, user interface 400 shows that the information asset group (i.e., “content set”) called “Dallas Diners” has been selected.

Once an information asset group for the beverage has been selected/created, server application 114 can receive, via the edit user interface, modifications to the attributes and/or information assets for the beverage in the context of the current information asset group (block 316). The modifications can comprise updates to existing attributes or information assets, deletions of existing attributes or information assets, and/or additions of new attributes or information assets. In one embodiment, if the modifications are directed to an alternative information asset group, the user need only specify the attribute/information assets that are different from the default information asset group; any attribute/information asset included in the alternative information asset group will override the corresponding attribute/information asset in the default information asset group, whereas everything else will be automatically defaulted from the default information asset group.

At block 318, server application 114 can store the modifications received at block 316 in database 116 such that the modifications are included in the currently selected information asset group for the beverage. Further, if a new alternative information asset group was created at block 314, server application 114 can generate a user interface that allows the user to associate the newly created group with a restaurant or set of restaurants (block 320). In this manner, the user can target the alternative information asset group to a particular subset of the restaurants that have visibility to the default information asset group.

As noted with respect to block 314, the attributes/information assets included in an alternative information asset group can act as overrides to the default attributes/information assets included in the default information asset group. Thus, if an alternative information asset group only includes, e.g., a modified description, restaurants associated with the alternative information asset group will have visibility to the default information asset group for everything but the description.

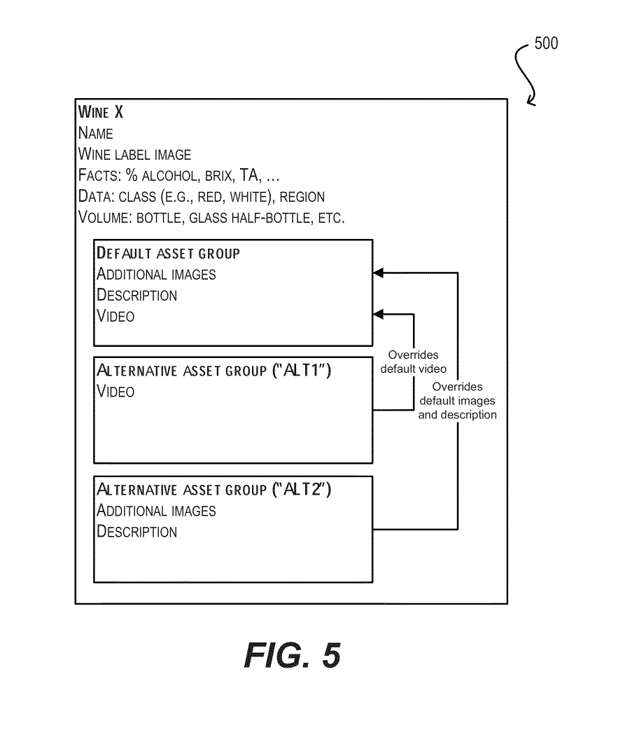

To clarify this behavior, FIG. 5 depicts a diagram 500 that shows how multiple information asset groups for a single beverage may interact with and override each other. In this example, a wine “X” has certain base attributes such as name, wine label image, facts, and so on. Wine X is also associated with three different information asset groups: (1) a default information asset group, a first alternative information asset group named “ALT1,” and a second alternative information asset group named “ALT2.” As shown, the default group includes additional images, a description, and a video, ALT1 includes a modified version of the video in the default group, and ALT2 includes modified versions of the additional images and description in ALT1.

If neither ALT1 nor ALT2 are associated with a restaurant (e.g., “R1”), restaurant R1 can have access to the base attributes of wine X and the additional images, description, and video included in the default group. On the other hand, if ALT1 (but not ALT2) is associated with restaurant R1, R1 can have access the base attributes of wine X, the additional images and description included in the default group, and the video included in ALT1. In this scenario, the video in ALT1 overrides the video in the default group, such that restaurant R1 does not have access/visibility to the default video. As another variation, if both ALT1 and ALT2 are associated with restaurant R1, R1 can have access to the base attributes of wine X, the video included in ALT1, and the additional images and description included in ALT2. In this scenario, the video in ALT1 overrides the video in the default group and the additional images and description in ALT2 override the additional images and description in default group, such that restaurant R1 does not have access/visibility to any of the default assets.

### Information Asset and Beverage List Entry—Restaurant Level

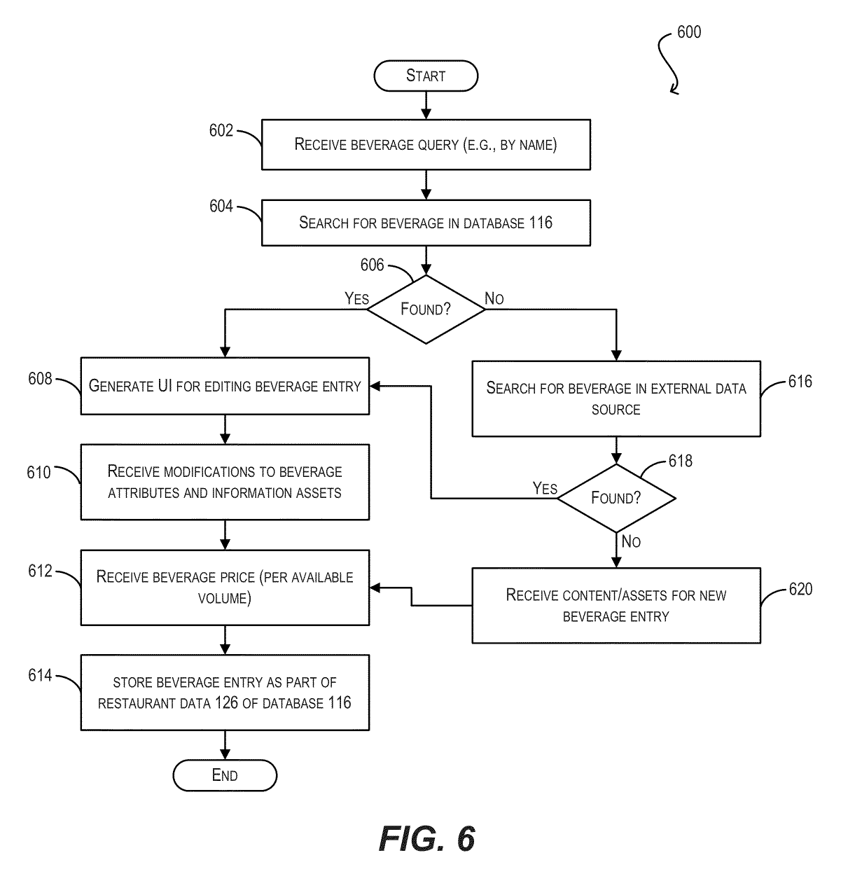

In addition to receiving information assets from beverage manufacturers via beverage manufacturer dashboard 118, server application 114 can also receive restaurant-level beverage information from restaurants 130-130N via restaurant dashboard 120. This restaurant-level information can include, e.g., a list of beverages offered for sale on-premise at a restaurant, beverage prices, and customizations/modifications to the information assets entered at the manufacturer-level. FIG. 6 illustrates a process 600 that can be performed by server application 114 for receiving and processing such restaurant-level beverage information according to an embodiment of the present invention.

At block 602, server application 114 can receive, from a user of restaurant dashboard 120 (e.g., a restaurant representative), a query for a particular beverage in database 116. For example, the query can identify the beverage by name using one or more required or optional elements. Server application 114 can then search for the beverage in database 116 (block 604).

If the beverage is found (block 606), server application 114 can generate a user interface within restaurant dashboard 120 that displays the attributes and information assets for the beverage (as defined by, e.g., the beverage manufacturer via beverage manufacturer dashboard 118) (block 608). This user interface can be similar to the edit user interface of dashboard 118 as described with respect to FIG. 3B; however, unlike the manufacturer-level user interface, this restaurant-level interface may not include any indication of information asset groups. Rather, the restaurant-level interface may only include those attributes and information assets of the beverage that are accessible/visible to the current restaurant per the asset group associations and override behavior described with respect to FIGS. 3B and 5.

At block 610, server application 114 can receive, from the user via the user interface generated at block 608, modifications to the presented attributes and information assets. In this manner, the user can customize the manufacturer-specified attributes and assets for his/her particular restaurant. These modifications can include updates to existing attributes or information assets, deletions of existing attributes or information assets, and/or additions of new attributes or information assets. For example, in the case of a wine, the user can enter sommelier's notes that are specific to the restaurant.

In some cases, the beverage manufacturer may not have entered any information assets at all for the beverage, or may have only provided incomplete information. In these situations, the missing or incomplete information can be filled in by the user using assets that the restaurant has acquired through other means, such as by scanning in a wine label, copying a description from a label or marketing materials, or the like.

In addition to receiving modifications to beverage attributes and information assets, server application 114 can also receive a price for the beverage per available volume (e.g., per glass, per bottle, etc.) (block 612). Server application 114 can then store the information received at blocks 610 and 612 as part of restaurant data 126 of database 116, and can add the beverage to the list of beverages offered for sale by the restaurant (block 614).

If, at block 606, the beverage is not found in database 116, server application 114 can alternatively search for the beverage in an external data source, such as the third-party beverage directories or aggregators described with respect to FIG. 3A (block 616). If the beverage is found in the external data source (block 618), server application 114 can pull attributes and information assets from the external data source and the flow of process 600 can proceed to block 608. On the other hand, if the beverage is not found in the external data source, server application 114 can enable the user to create an entirely new beverage entry with new attributes and new information assets (block 620). The flow of process 600 can then proceed to block 612.

### Beverage Information Synchronization and Presentation at Restaurants

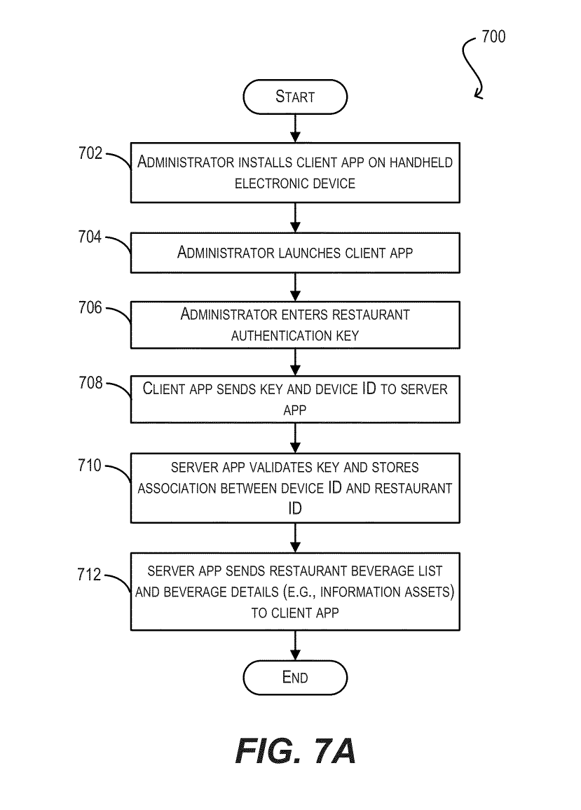

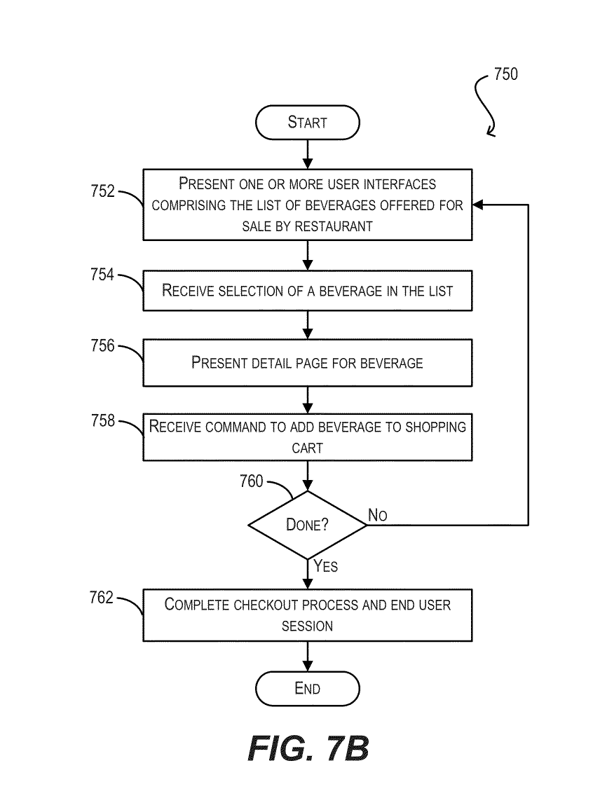

Once manufacturer-level and restaurant-level beverage information has been received and stored in database 116, server application 114 can synchronize this information (or a portion thereof) with client applications 132-132N running on handheld electronic devices 110-110N. The beverage information can then be presented, via client applications 132-132N, to restaurant patrons at the time of dining. FIG. 7A illustrates a process 700 for initializing a handheld electronic device 110 deployed at a restaurant 130 so that client application 132 running on device 110 can properly synchronize with server application 114 according to an embodiment of the present invention.

At block 702, an administrator for restaurant 130 can install client application 132 on handheld electronic device 110. For example, the administrator can download the application from an online “app store,” or can install the application from a local storage device (e.g., a USB drive, a flash memory card, etc.).

At blocks 704 and 706, the administrator can launch client application 132 on handheld electronic device 110 and, in response to an application prompt, enter a restaurant authentication key. The restaurant authentication key can correspond to a private key that is known only to server application 114 and the administrators of restaurant 130 for the purpose of controlling access to the restaurant's information in database 116.

Upon receiving the authentication key, client application 132 can transmit the key and a unique device identifier to server application 114 (block 708). In response, server application 114 can validate the authentication key and, if the key is valid, store an association between the device identifier and a unique identifier for restaurant 130 in device data 134 of database 116 (block 710). With this stored association, server application 114 can know that handheld electronic device 110 has been securely activated by an administrator of restaurant 130 and is now in use at that restaurant.

Finally, at block 712, server application 114 can transmit the stored beverage list for restaurant 130 and related information assets to client application 132, thereby synchronizing database 116 with application 132. Client application 132 can then cache the received information in, e.g., a database local to handheld electronic device 110 for later presentation to patrons of restaurant 130.

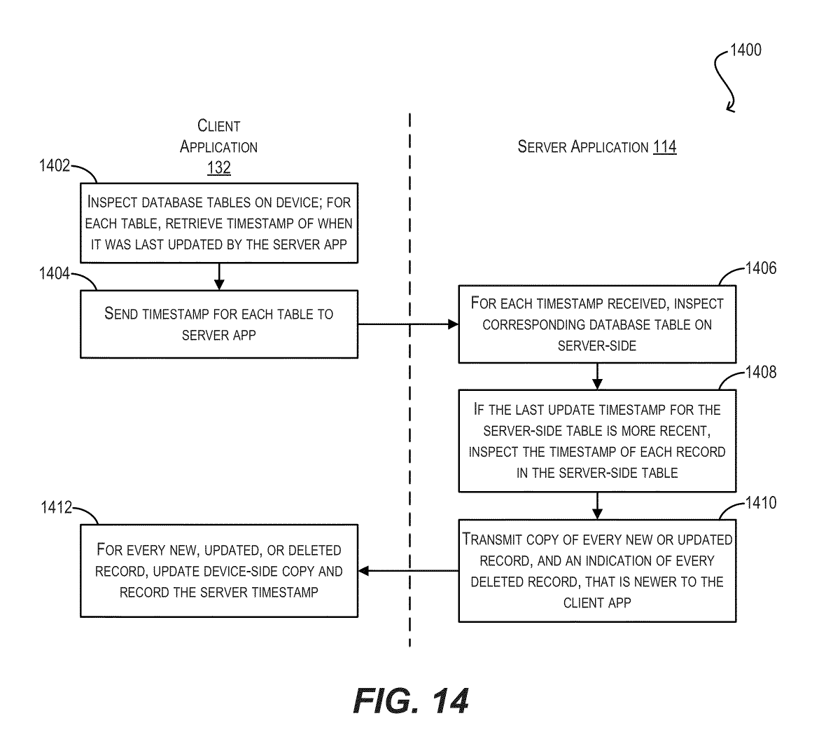

Although not shown in FIG. 7A, in certain embodiments server application 114 can re-synchronize the information in database 116 with the local database used by client application 132 on a periodic basis. This can ensure that client application 132 always has access to the most up-to-date beverage information. A particular method for performing this re-synchronization process in an incremental fashion is described with respect to FIG. 14 below.

FIG. 7B illustrates a process 750 that can be performed by client application 132 (subsequently to process 700) for presenting beverage information to a patron of restaurant 130 at the time of dining according to an embodiment of the present invention.

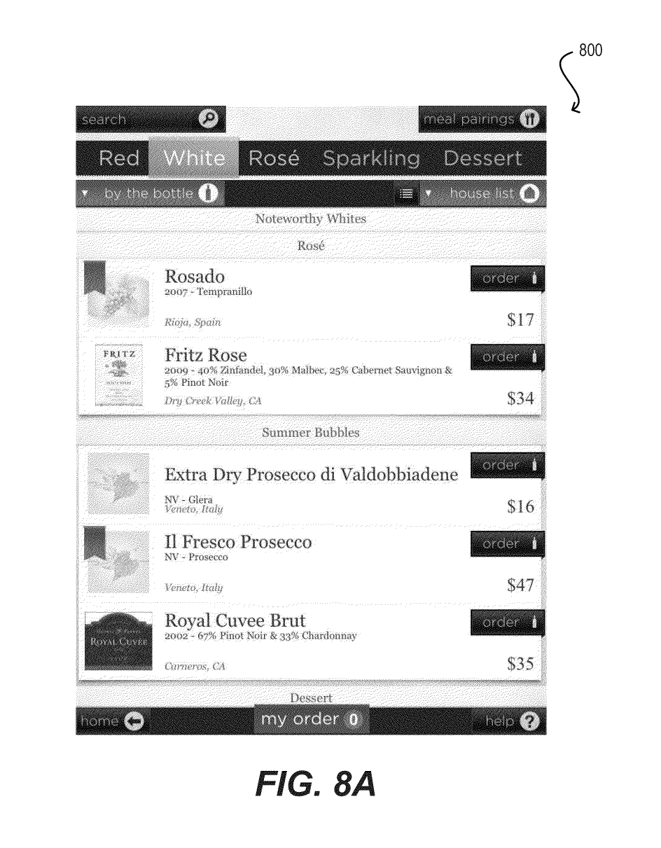

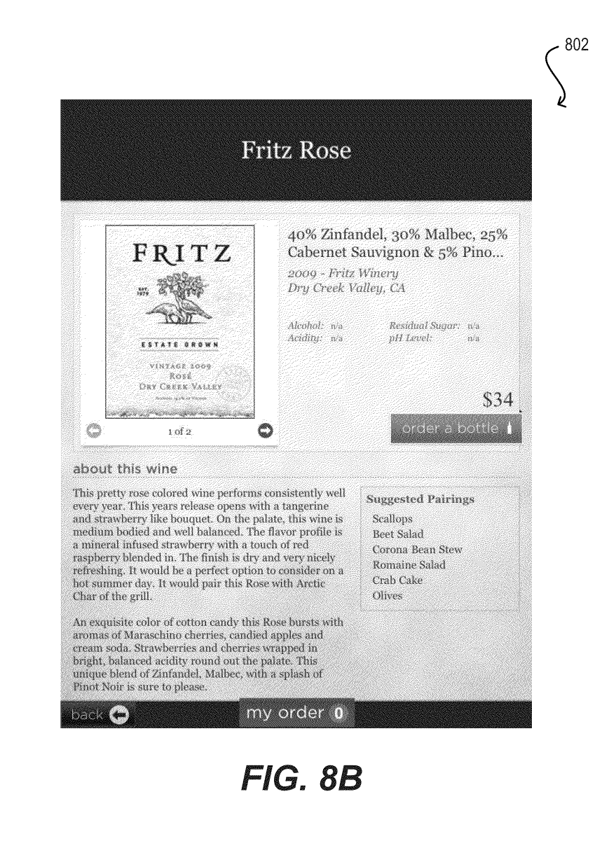

At block 752, client application 132 can present one or more user interfaces comprising the list of beverages offered for sale by restaurant 130. This list can include, e.g., the name of each beverage, the price of each beverage, and the volume by which it is offered (e.g., by the glass or by the bottle). In a particular embodiment, the list can be segmented into different categories (e.g., white wines, red wines, etc.) to facilitate navigation. An example of such a beverage list user interface is shown in FIG. 8A as user interface 800.

At block 754, client application 132 can receive, from the restaurant patron using the application, a selection of a particular beverage in the beverage list. In response, client application 132 can present a beverage “detail” page that includes one or more of the information assets that have been defined for the selected beverage via beverage manufacturer dashboard 118 and/or restaurant dashboard 120 (block 756). For example, in the case of a wine, the detail page can include a description of the wine, technical details for the wine, a picture of the wine label, suggested food pairings, and more. Through this detail page, the restaurant patron may become more educated about the beverage and thus may become more inclined to try it. As example of such a wine detail page is shown in FIG. 8B as user interface 802.

At block 758, the restaurant patron may choose to purchase the beverage that is presented in block 756. Accordingly, client application 132 can receive a command to add the beverage to the patron's beverage “shopping cart.” If the patron wishes to continue browsing other beverages in the beverage list, the flow for process 750 can return to block 752. Alternatively, if the patron has finished reviewing/selecting beverages (block 760), client application 132 can complete the checkout process and end the patron's session (block 762).

In certain embodiments, each table in restaurant 130 can include a radio frequency identification (RFID) tag that is configured to broadcast the table's number. In these embodiments, client application 132 running on handheld electronic device 110 can read this number from the RFID tag to facilitate the beverage checkout process. For instance, when finalizing the checkout process at block 762, client application 132 can automatically transmit the beverages in the shopping cart and the table number to a point-of-sale (POS) system at restaurant 130. Thus, the POS system can know exactly which table has ordered which beverages, without requiring a server to manually enter this information into the system.

### Captured Data and Analytics

Throughout a restaurant patron's interaction with client application 132 at the time of dining, client application 132 can collect data regarding the patron's browsing and purchasing behavior. This information can then be sent back to server application 114 and stored as captured data 136 in database 116. Examples of data that can be collected by client application 132 include:
1. Interactions that result in the patron viewing a detail page for a beverage (views)
2. Interactions that result in the patron adding a beverage to the shopping cart (cart adds)
3. Views that result in the patron not purchasing the beverage (exits)
4. Beverages added to the shopping cart that are subsequently removed (abandons)
5. Beverages that are added to the shopping cart and are purchased (sales)
6. Anonymous demographic data of the patron

In one embodiment, the anonymous demographic data noted above can be collected via functionality in client application 132 that integrates with email or one or more social networks. For example, at the time of viewing or purchasing a beverage using client application 132, the patron can enter his/her email address or social network login and thereby share information regarding the beverage with others. Client application 132 can then use the patron's email address or social network login to retrieve anonymous demographic data regarding the patron from the social network or a third-party service.

Once captured data 136 has been collected and stored in database 116, server application 114 can organize or “slice” captured data 136 in a number of different ways that may be of interest to beverage manufacturers, beverage wholesalers, and/or restaurants. For example, server application 114 can organize captured data 136 by beverage manufacturer or brand, price, beverage type, restaurant, geographic region, beverage wholesaler, and more. In addition, server application 114 can calculate certain metrics for manufacturers and wholesalers, such as bounce rate (exits divided by views), conversion rate (sales divided by views), and abandon rate (abandons divided by cart adds).

Finally, server application 114 can present captured data 136 and the calculated metrics in the form of reports via dashboards 118, 120, and 122. In various embodiments, the reports can be customized to provide value to each supply chain entity (e.g., beverage manufacturer, restaurant, and beverage wholesaler). For instance, beverage manufacturers can be provided reports that identify, e.g., bounce rates, abandon rates, sales data, and customer demographic data for one or more beverages. Restaurants can be provided reports that identify, e.g., beverages that are low in inventory and top selling beverages by glass and/or bottle. And beverage wholesalers can be provided reports that identify, e.g., top selling categories of beverages, (e.g., by price, varietal) and beverages that have recently sold out for a given account.

### A/B Testing

Generally speaking, A/B testing (also known as split testing or bucket testing) is a method of marketing testing by which a baseline control sample is compared to a variety of single-variable test samples in order to improve customer response rates. In particular, A/B testing can comprise two versions of a marketing element (A and B) and a metric that defines success. To determine which version is better, the testing system subjects both versions to experimentation simultaneously. In the end, the testing system measures which version was more successful (e.g., which version was better received by customers or resulted in better sales) and selects that version for real-world use.

In the beverage industry, beverage manufacturers are constantly looking for ways to improve their sales and revenues by optimizing their marketing messaging to consumers. Accordingly, in certain embodiments, an A/B testing feature can be provided that allows beverage manufacturers to setup, via beverage manufacturer dashboard 118, an A/B test for testing the effectiveness of the beverage information asset groups that are presented to restaurant patrons at the time of dining. With this feature, beverage manufacturers can fine-tune the information assets that are delivered for a particular beverage at a particular restaurant (or set of restaurants) to optimize customer receptiveness and sales.

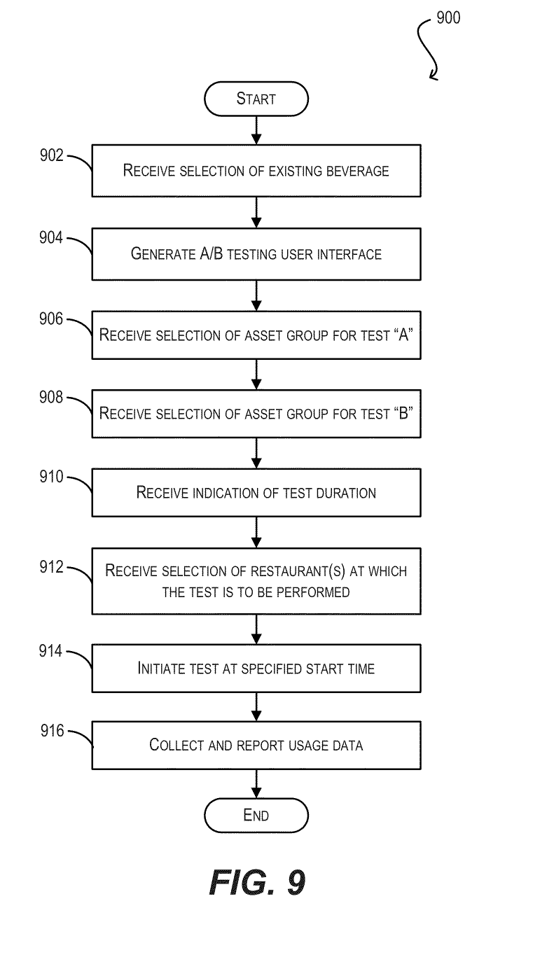

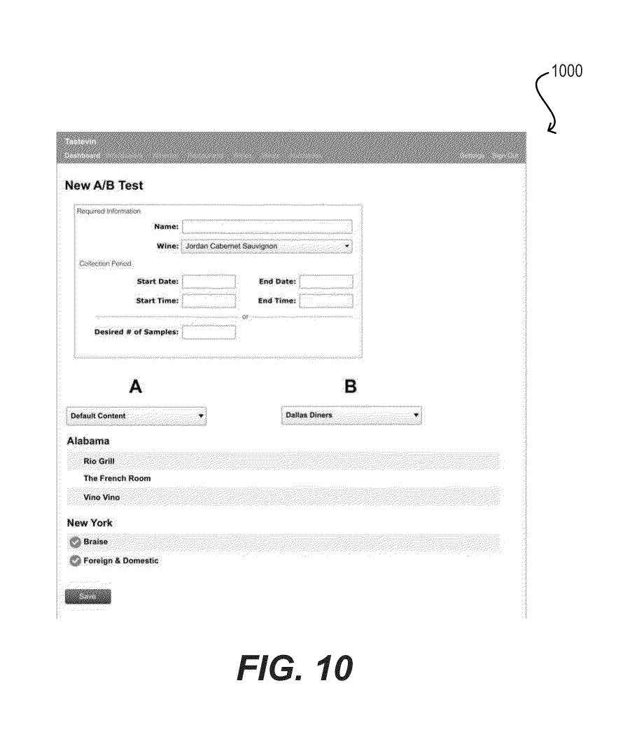

FIG. 9 illustrates a process 900 that can be performed by server application 114 for establishing and carrying out an A/B test for a beverage according to an embodiment of the present invention. At block 902, server application 114 can receive, from a user via beverage manufacturer dashboard 118, a selection of (or query for) an existing beverage for the purpose of establishing an A/B test. In response, server application 114 can retrieve information regarding the beverage from database 116 and generate an A/B testing user interface (block 904). An example of such an A/B testing user interface is shown in FIG. 10 as user interface 1000.

At blocks 906 through 912, server application 114 can receive, from the user via the A/B testing user interface generated at block 904, various pieces of information for defining the parameters of the A/B test. For example, at blocks 906 and 908, server application 114 can receive selections of two different information asset groups for the beverage. These information asset groups can serve as the test media for scenarios “A” and “B” in the A/B test. At block 910, server application 114 can receive an indication of the duration of the A/B test. For instance, as part of block 910, server application 114 can receive a start date/time and end date/time indicating the total time period over which the test will be active. Alternatively, server application 114 can receive a number of A/B samples that are desired. In these embodiments, once the desired number of samples (or a desired confidence level) is reached, the A/B test can be automatically concluded. And at block 912, server application 114 can receive a selection of the restaurant(s) at which the A/B test will be conducted.

Once the parameters of the A/B test are received at blocks 906-912, server application 114 can initiate the test at the specified start time (block 914). This can comprise, e.g., looping through a list of the handheld electronic devices that are actively in use at the selected restaurant(s) and randomly assigning each handheld electronic device to receive the information assets for scenario A or B. In a particular embodiment, the randomization algorithm can ensure that there is a 50/50 split between devices that are assigned to A or B. Server application 114 can then transmit the information assets for A or B to the appropriate handheld electronic devices for presentation to restaurant patrons.

During the testing period, client application 132 operating on the handheld electronic devices can collect various types of information regarding user interaction with the devices. This information can include:
1. How long information on the detail page for the beverage is viewed. This can be broken down by individual information assets, such as pictures, videos, etc. In the case of a video, the collected information can include how much of the video was viewed, how many times it was viewed, etc.
2. Whether the beverage is ultimately purchased
3. Demographic information about the user (obtainable from email/social network integration)

The collected information can be subsequently transmitted to server application 114 for reporting and analysis (block 916).

As noted with respect to FIG. 3B, beverage manufacturers have the ability to specify a default information asset group for a beverage, where the information assets in the default information asset group are accessible/visible to all restaurants. This feature can be leveraged by beverage manufacturers at the conclusion of an A/B test to rapidly update their information assets for a beverage across restaurants. For example, a beverage manufacturer may determine that the information assets for scenario A in a completed A/B test are optimal for a particular beverage. As a result, the beverage manufacturer can update the default information asset group for the beverage to reflect the information assets in scenario A, thereby enabling all restaurants to have access to the optimal assets.

In some embodiments, once an A/B test for a beverage has been initiated per block 914, restaurants will not be able to replace or remove the information assets for the beverage via restaurant dashboard 120. This ensures that the integrity of the A/B testing scenarios remain intact throughout the testing period. However, restaurants may be able to add information assets for the beverage, such as sommelier's notes. Such added assets can be displayed in both the A and B scenarios. If a restaurant attempts to replace or remove an information asset while an A/B test is taking place, server application 114 can generate a notification indicating that the restaurant's changes will not take effect until the A/B test is completed.

### Inventory Management

Certain embodiments of the present invention include an inventory management feature that enables restaurants to take a hard inventory of their beverages using client applications 132-132N executing on handheld electronic devices 110-110N. Generally speaking, taking a manual inventory of beverages such as wines is a time-consuming and error-prone process. For example, a wine buyer or other restaurant employee will typically go into their wine storage area (e.g., cellar) with a notepad or printout. The wine buyer will note how many cases and bottles of each wine are present on the notepad/printout, and then return to a computer to manually transfer that information to a spreadsheet or database.

With the inventory management feature described herein, the wine buyer can take a handheld electronic device 110 into the wine storage area and start client application 132 in an “administrator” mode. When in administrator mode, client application 132 can accept beverage inventory information. The wine buyer can then enter the inventory count for each wine directly into client application 132, as well as other related information (e.g., purpose of the inventory count, notes, etc.). Once the wine buyer has finished entering inventory information into client application 132, the inventory information can be automatically synchronized with server application 114 and stored in database 116.

In addition, the wine buyer can subsequently login to restaurant dashboard 120 (via management device 106 or another computer) to access additional inventory management functionality. For instance, the wine buyer can note the wholesaler (i.e., vendor) for each wine, and enter other information items such as par value (i.e., number of bottles in stock that triggers a re-order) and glasses per bottle. The wine buyer can also print reports of wines to be re-ordered, view or print a “pick list” that displays all of the wines that are at or below par value (organized by, e.g., wholesaler), and/or sign up to be notified via email about wines that are at low inventory counts. In certain embodiments, such email notifications can be pushed to a number of different recipients that may be interested in restaurant-level inventory information including the wine buyer, wine wholesalers, and others.

In a particular embodiment, server application 114 can integrate with one or more third-party systems (e.g., POS or inventory control systems). This integration allows server application 114 to be notified when certain inventory-impacting events occur, such as when a bottle of wine is sold at the restaurant, or when new cases of wine have been received.

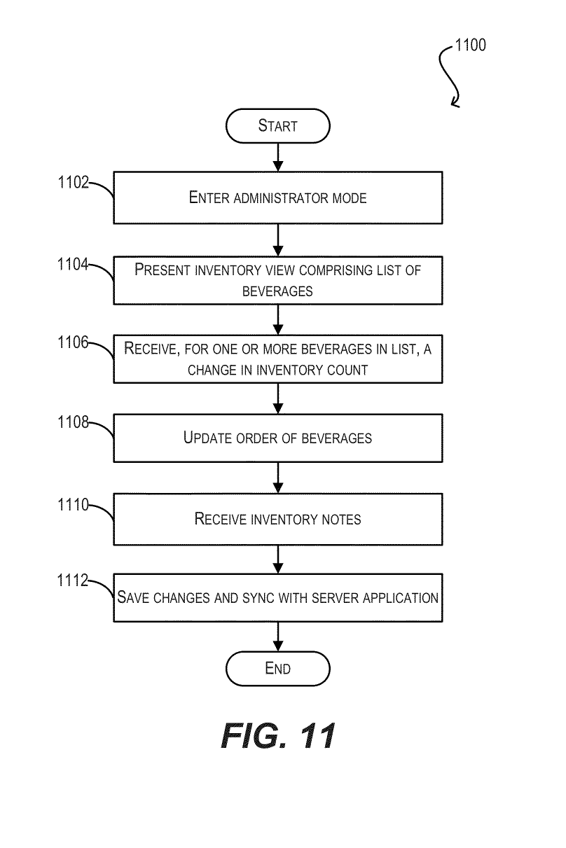

FIG. 11 illustrates a process 1100 that can be performed by client application 132 running on handheld electronic device 110 for facilitating beverage inventory management according to an embodiment of the present invention. At block 1102, client application 132 can enter an administrator mode that configures application 132 to provide inventory management functions for a particular restaurant.

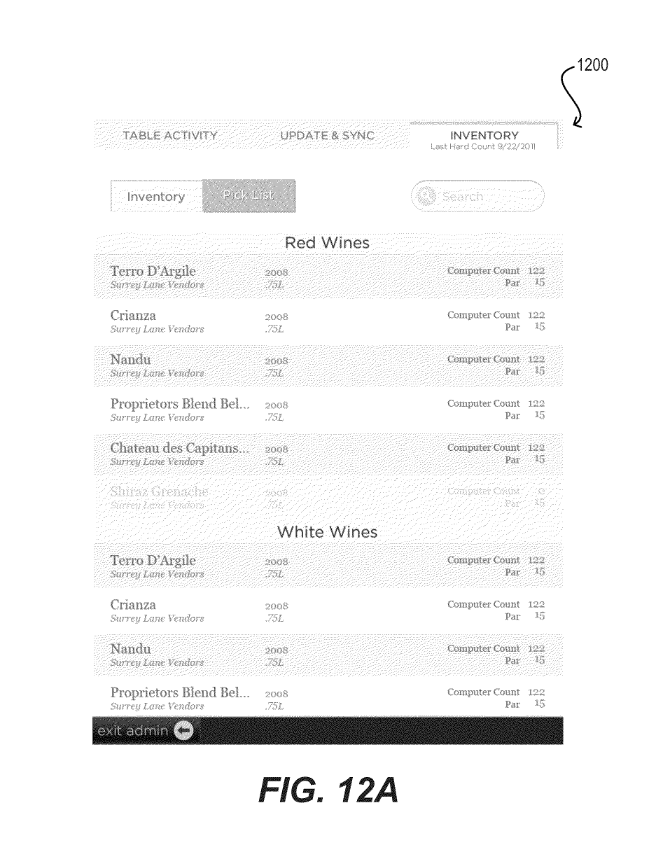

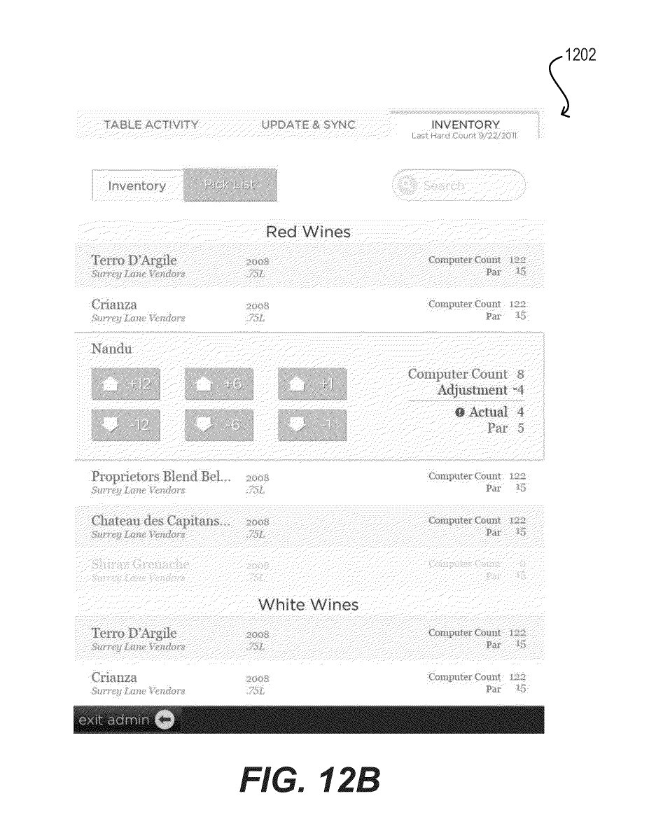

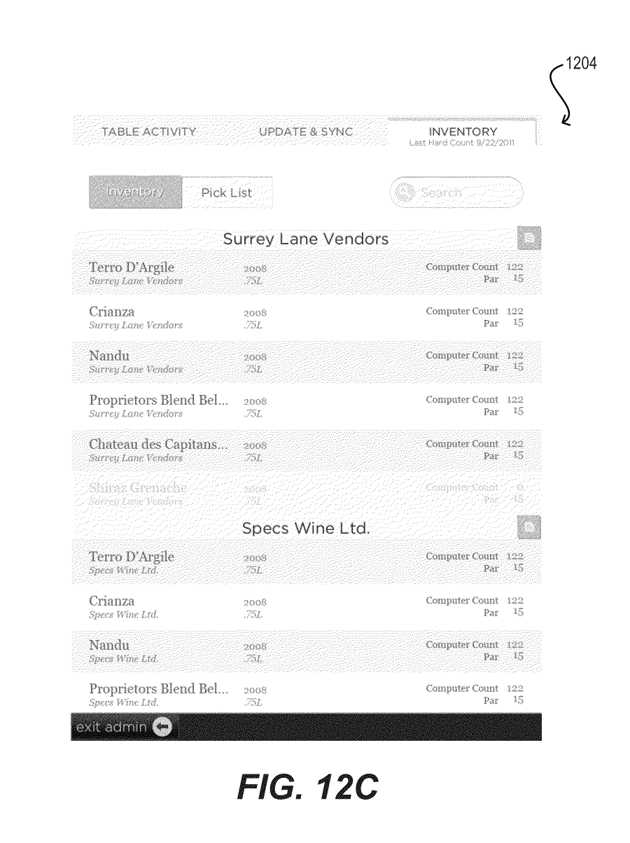

At block 1104, client application 132 can present, to a user, an initial inventory view comprising a list of beverages stocked by the restaurant. An example of such an inventory view is depicted in FIG. 12A as user interface 1200. As shown in FIG. 12A, the inventory view can include the name of each beverage (organized by, e.g., wholesaler), the current inventory count, and the par value. In one embodiment, if no inventory was previously taken via client application 132, the beverages in the initial inventory view can be sorted in the same order as the “restaurant patron” beverage list view depicted in FIG. 8A. However, if an inventory was previously taken, the beverages in the inventory view can be sorted to reflect the order in which inventory information was entered during the previous inventory. This sorting feature is described in further detail below.

At block 1106, client application 132 can receive, from the user, a change in inventory count for one or more beverages in the inventory view. For example, the user can select a beverage in the inventory view that needs to be updated. The inventory view user interface can then display one or more controls (e.g., buttons, pick lists, text entry fields, etc.) that allow the user to provide a new inventory count for the beverage. An example of such controls is depicted in user interface 1202 of FIG. 12B.

In one embodiment, as the user is entering updated beverage inventory counts, client application 132 can automatically update the order of beverages in the inventory view (block 1108). This can be useful because, in many cases, beverages such as wines are stored in a particular physical order in a storage area (e.g., bins or slots in a wall rack). At the time of carrying out the inventory, the user needs to walk from one bin/slot to another, and this physical order will be the same each time. Accordingly, to facilitate the process of entering inventory information, client application 132 can sort the beverages in the inventory view in the order that the updated beverage counts are entered. This can greatly simplify the data entry process in subsequent inventories, since the location of each beverage in the inventory view will be associated with the physical location of that beverage in the restaurant storage area.

Once the beverage inventory counts have been entered/updated, client application 132 can receive additional inventory-related information from the user, such as notes indicating the purpose of the current inventory (block 1110). Client application 132 can then save the current inventory locally and synchronize the inventory information with server application 114 for storage in database 116 (block 1112).

Although not shown in FIG. 11, in certain embodiments client application 132 can also present a “pick list” view of a restaurant's beverage inventory to a user. An example of such a pick list view in shown in FIG. 12C as user interface 1204. This pick list view only includes beverages in the inventory that are at or below par value. Thus, the user can easily determine, at a glance, which beverages need to be re-ordered.

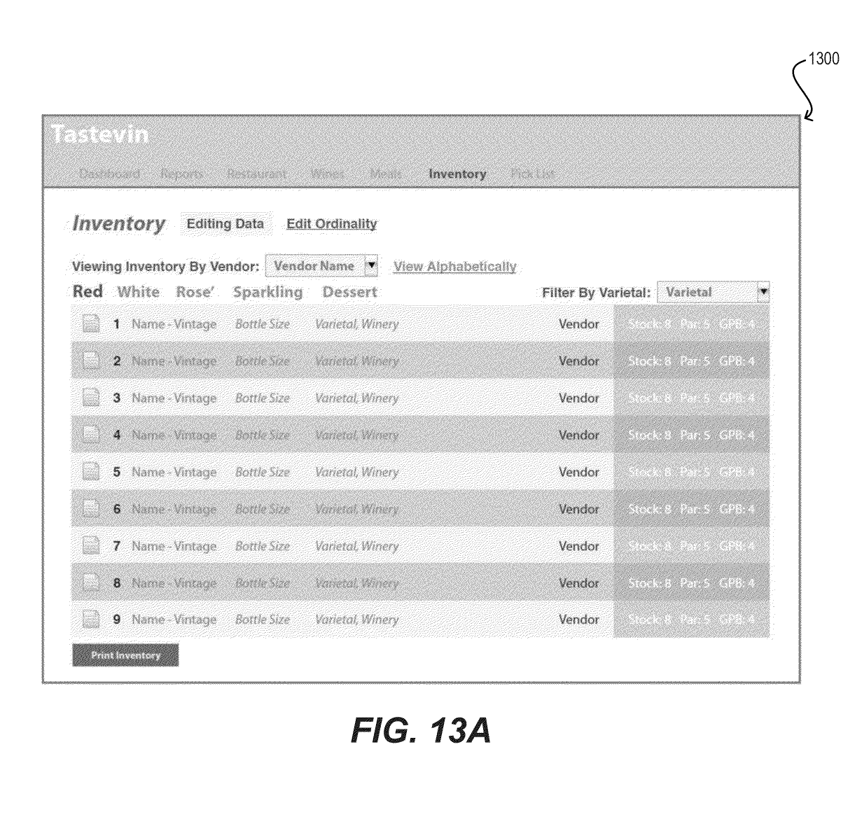

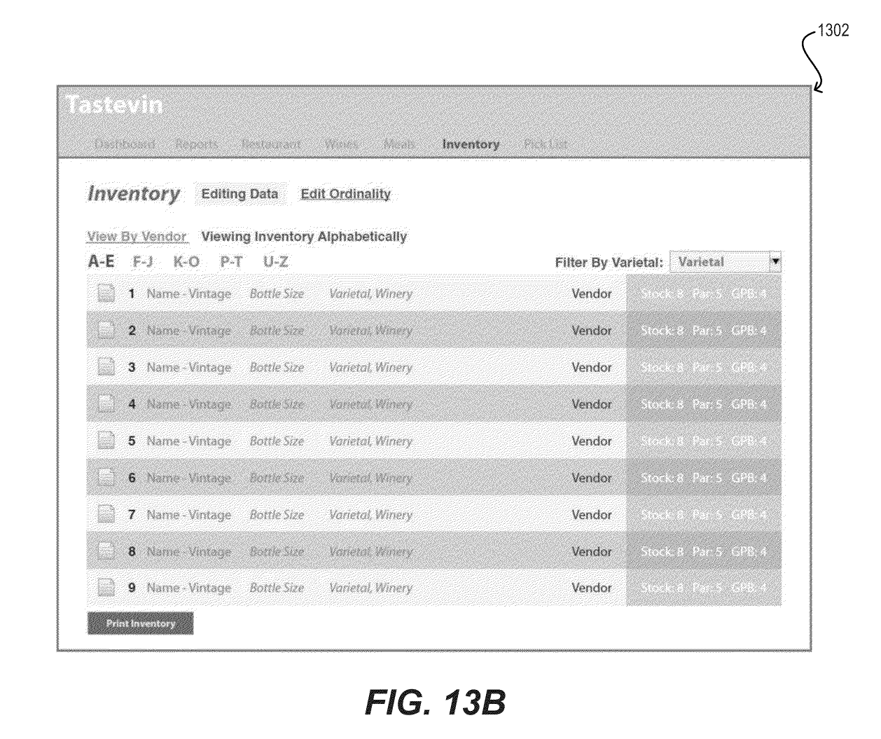

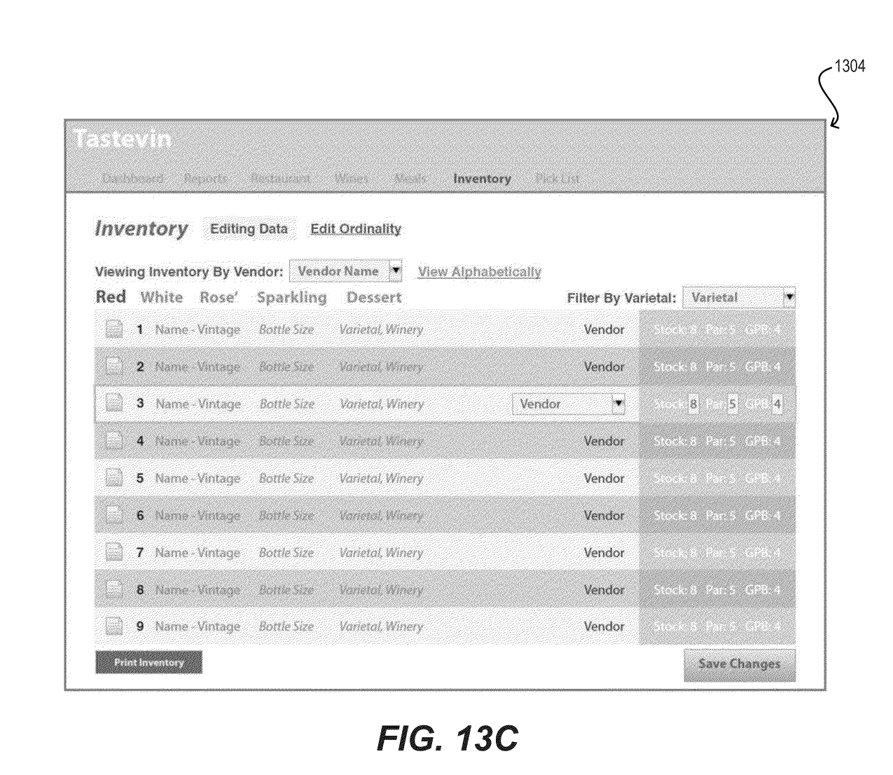

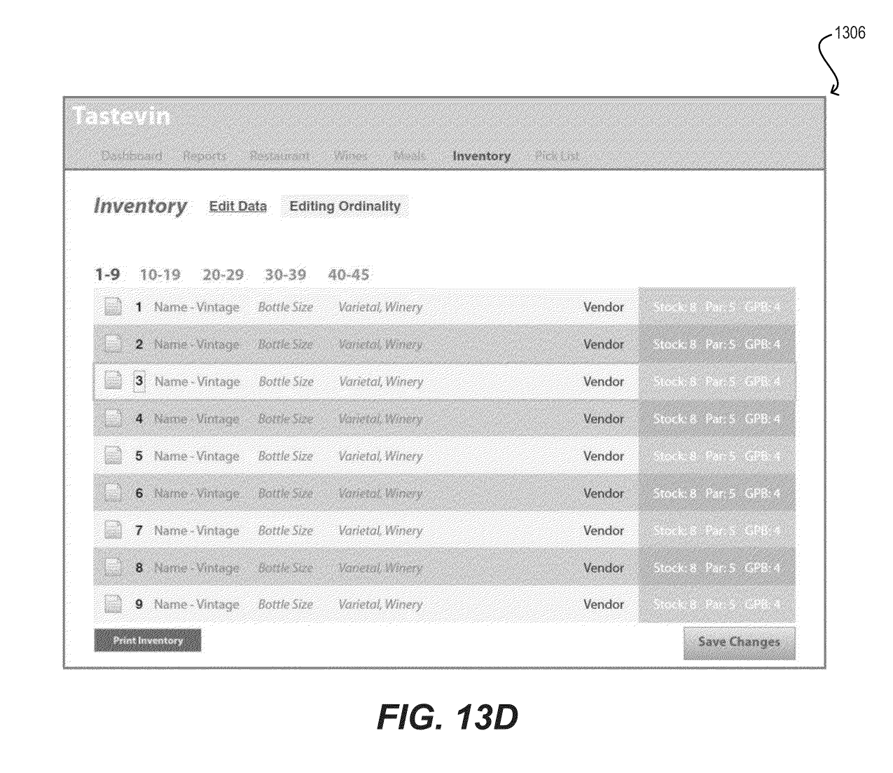

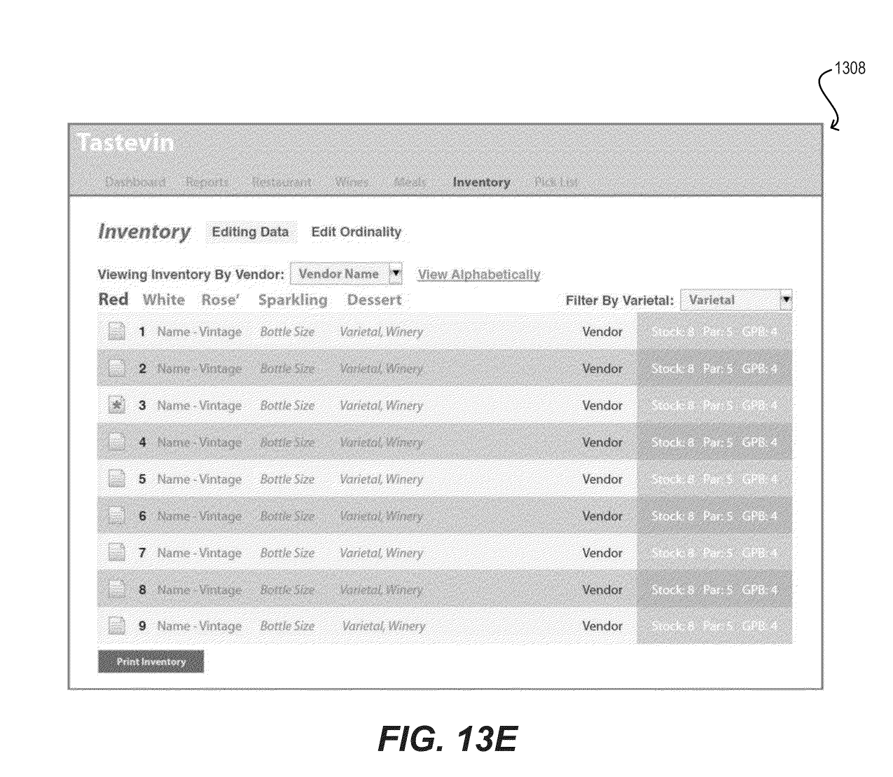

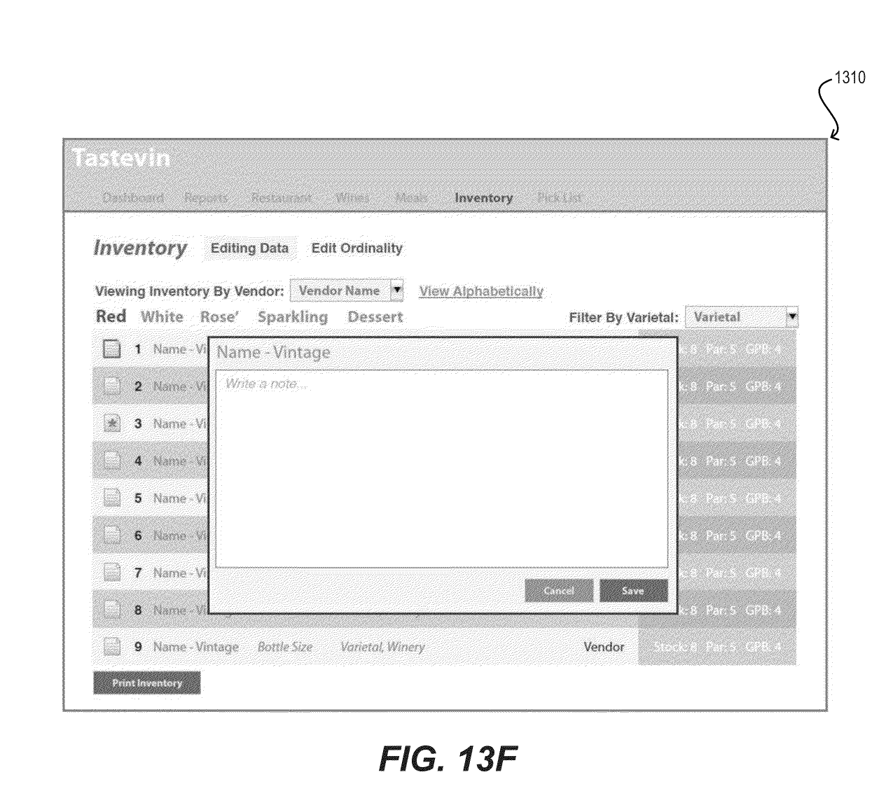

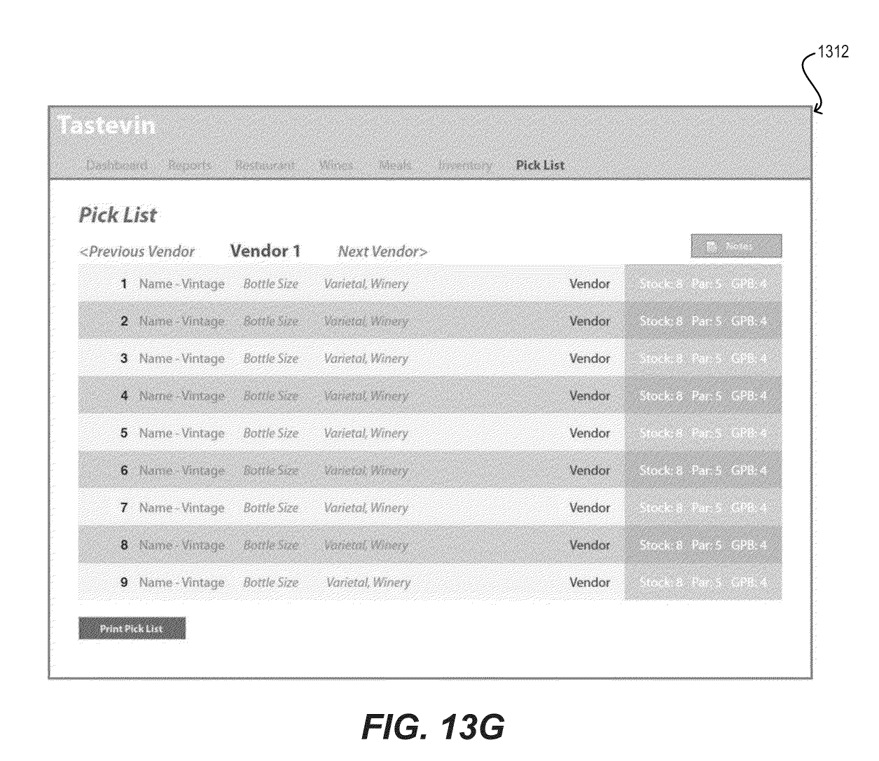

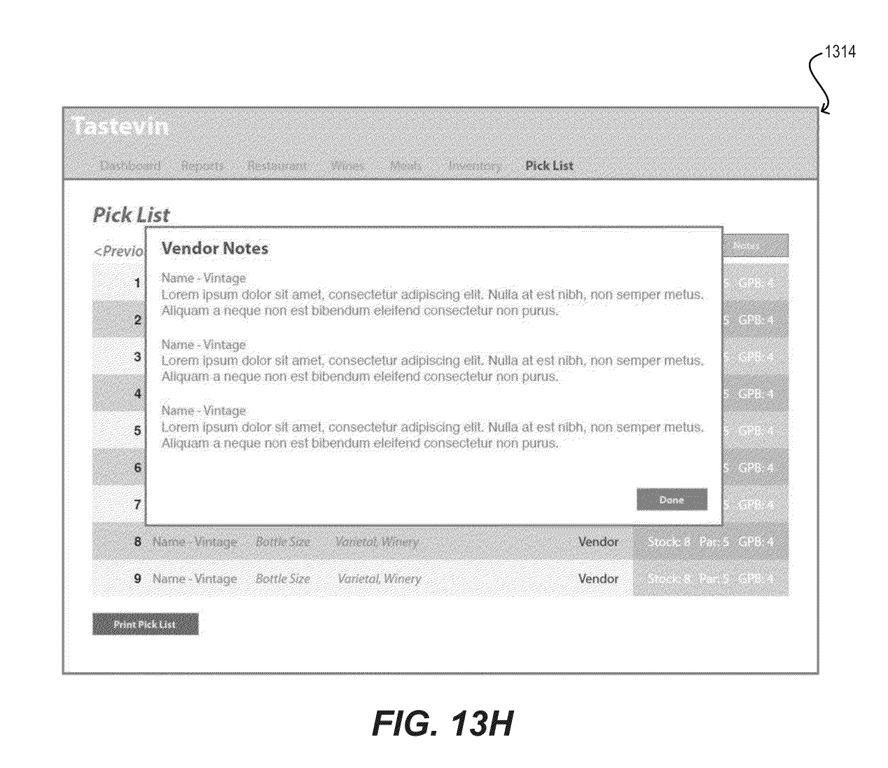

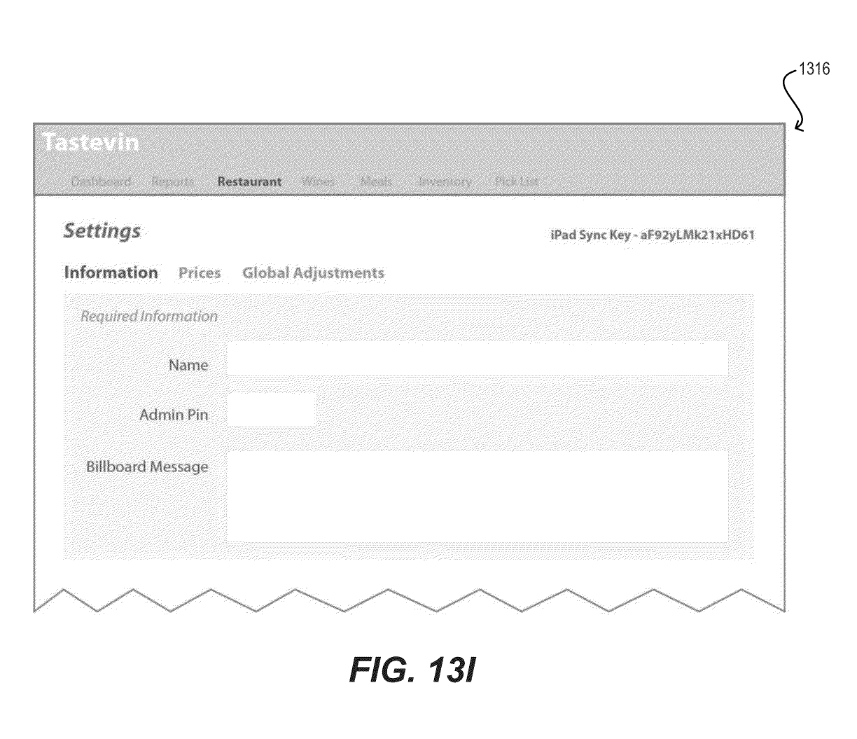

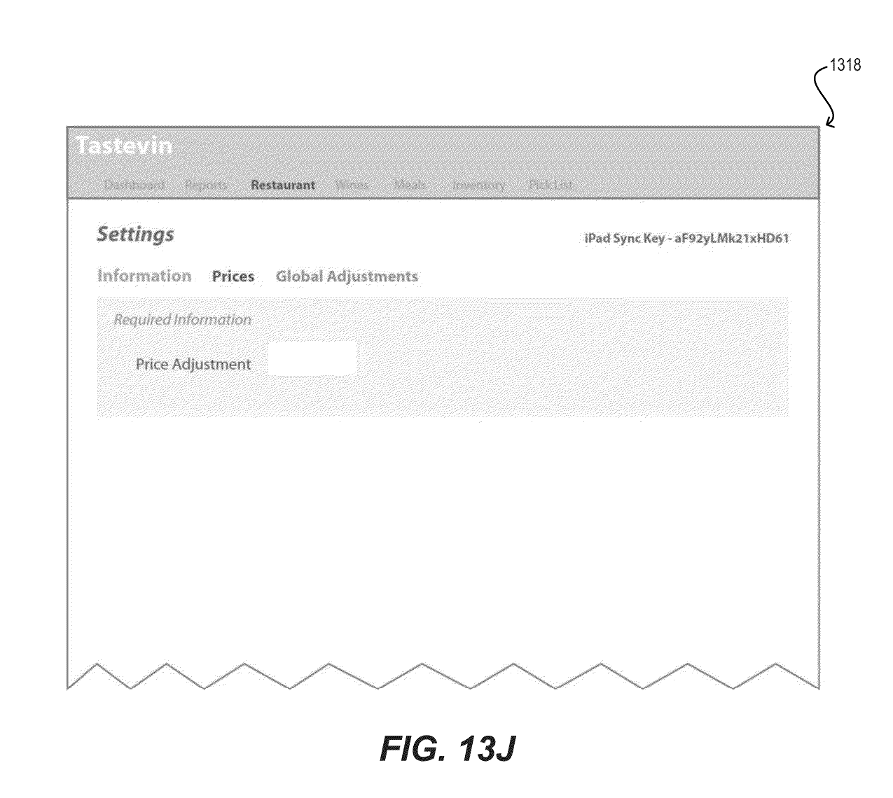

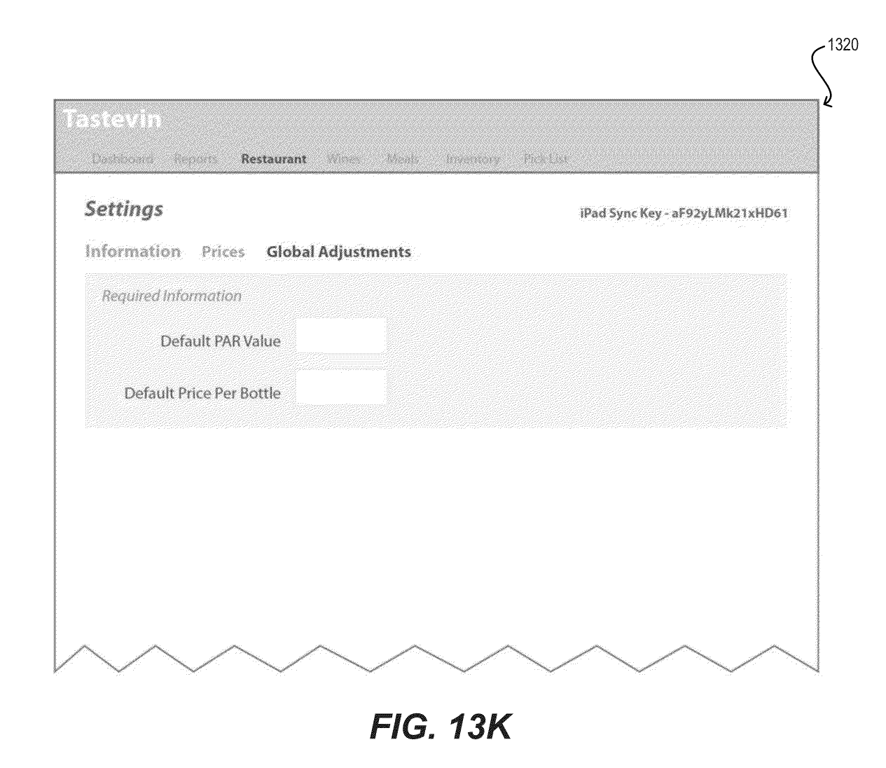

FIGS. 13A-13K depict various user interfaces of restaurant dashboard 120 that can be used by a restaurant to access additional inventory management functions of the present invention. For example, FIGS. 13A-13F depict user interfaces 1300-1310 corresponding to an inventory screen of restaurant dashboard 120 that includes a list of beverages stocked by the restaurant. User interface 1300 illustrates the inventory screen in an “editing data” mode that allows a user to edit inventory-related information for each beverage. User interface 1302 illustrates the inventory screen ordered alphabetically by beverage name. User interface 1304 illustrates the state of the inventory screen after the user has selected a beverage in the beverage list. As shown, controls are made available that allow the user to update various inventory-related attributes such as vendor, stock, par, and glasses per bottle. User interface 1306 illustrates the inventory screen in an “editing ordinality” mode that allows the user to change the order of the beverages in the beverage list. User interface 1308 illustrates that one or more beverages in the inventory screen can be associated with a note (indicated by the star icon in row 3). And user interface 1310 illustrates a dialog box for entering a note for a beverage.

FIGS. 13G and 13H depict user interfaces 1312 and 1314 corresponding to a pick list screen of restaurant dashboard 120. As shown in user interface 1312, the pick list can display all of the beverages in the inventory that are at or below their respective par values, grouped by wholesaler/vendor. The information presented in user interface 1312 can be substantially similar to the information presented in the client-side pick list view of FIG. 12C. User interface 1314 illustrates a “vendor notes” popup box that can be displayed in the pick list screen when the “Notes” button is activated.

FIG. 13I depicts a user interface 1316 that allows a user to enter restaurant-specific administrative data (e.g., name, administration PIN/password, and billboard message).

FIG. 13J depicts a user interface 1318 that allows a user to apply a price adjustment to all beverages in the inventory. In one embodiment, this price adjustment can be automatically applied to all beverages and may not be overridden for specific beverages.

FIG. 13K depicts a user interface 1320 that allows a user to define a default price per bottle and default par value for all beverages in the inventory. In one embodiment, these values can be overridden by making adjustments to specific beverages.

### Incremental Re-synchronization

As noted with respect to FIG. 7A, after server application 114 has performed an initial synchronization with a client application 132 to copy beverage information to handheld electronic device 110, server application 114 can re-synchronize with client application 132 on a periodic basis (e.g., every few minutes or hours). In a particular embodiment, this periodic re-synchronization can be performed in an incremental manner; in other words, server application 114 can only send over delta changes to client application 132 upon each re-synchronization, rather than the entirety of the beverage information stored in database 116. This minimizes the amount of bandwidth and time needed to execute the re-synchronization process.

FIG. 14 illustrates a process 1400 that can be carried out by client application 132 and server application 114 for performing incremental re-synchronization according to an embodiment of the present invention. At block 1402, client application 132 can inspect the local database tables resident on handheld electronic device 110 and, for each database table, retrieve a timestamp indicating when the table was last updated/synchronized by server application 114. Client application 132 can then send the timestamp for each table to server application 114 as part of a re-synchronization request (block 1404).

At block 1406, server application 114 can, for each timestamp received, inspect the server-side database table (i.e., table in database 116) that corresponds to the device-side database table. If the last update timestamp for the server-side database table is more recent than the received timestamp, server application can inspect the timestamp of each record in the server-side table (block 1408).

At block 1410, server application 114 can transmit, to client application 132, a copy of every new or updated record (and an indication of every deleted record) in the server-side database table that has a timestamp newer than the received timestamp, but no newer than the timestamp of the initial re-synchronization request from client application 132. Server application 114 can, by referring to the time of the initial re-synchronization request, avoid delivering compound records that were not completely ready at the time that the re-synchronization started. In response, client application 132 can update, for each new, updated, or deleted record, the device-side entry in the device-side database table (block 1412). Finally, client application 132 can update the server update timestamp for the device-side database table to reflect the current time.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A system comprising:
a storage component configured to store:
first information pertaining to a plurality of beverages, the first information including, for each beverage, information assets associated with the beverage; and
second information pertaining to a plurality of restaurants, the second information including, for each restaurant, a list of beverages from the plurality of beverages that are offered for sale by the restaurant; and
a processor configured to:
transmit at least a portion of the first information and at least a portion of the second information to a plurality of handheld electronic devices used by customers at the plurality of restaurants, the transmitted portions enabling a customer dining at a restaurant to view, via the customer's handheld electronic device, the list of beverages offered for sale by the restaurant and the information assets associated with each beverage.

2. The system of claim 1 wherein the storage component is further configured to store third information pertaining to a plurality of beverage manufacturers, and wherein the processor is further configured to generate a first set of user interfaces accessible by the plurality of beverage manufacturers for managing a subset of the first information.

3. The system of claim 2 wherein the processor is further configured to generate a second set of user interfaces accessible by the plurality of restaurants for managing a subset of the second information.

4. The system of claim 3 wherein the storage component is further configured to store fourth information pertaining to data captured via the plurality of handheld electronic devices, the captured data including sales data and demographics data.

5. The system of claim 4 wherein the processor is further configured to generate a third set of user interfaces accessible by a plurality of beverage wholesalers, and wherein the captured data is made available to the plurality of beverage manufacturers, the plurality of restaurants, and the plurality of beverage wholesalers via the first, second, and third sets of user interfaces respectively.

6. The system of claim 2 wherein the first set of user interfaces enables each beverage manufacturer to define a plurality of information asset groups for each beverage produced by the beverage manufacturer.

7. The system of claim 6 wherein the plurality of information asset groups includes a default group and one or more alternative groups.

8. The system of claim 6 wherein at least one information asset group is associated with a specific restaurant or set of restaurants.

9. The system of claim 6 wherein the first set of user interfaces further enables each beverage manufacturer to execute an A/B test for a beverage by:
selecting first and second information asset groups for the beverage;
selecting a location for the A/B test, the location comprising one or more restaurants in the plurality of restaurants; and
selecting a duration for the A/B test.

10. The system of claim 9 wherein executing the A/B test comprises providing the first information asset group to a first set of handheld electronic devices at the one or more restaurants, providing the second information asset group to a second set of handheld electronic device at the one or more restaurants, and collecting usage data from the first and second sets of handheld electronic devices.

11. The system of claim 1 wherein the second information further includes an inventory of beverages for at least one restaurant in the plurality of restaurants.

12. The system of claim 11 wherein at least one handheld electronic device in the plurality of handheld electronic devices is operable in an administrator mode, the administrator mode enabling a user of the at least one handheld electronic device to enter information for updating the inventory of beverages for the at least one restaurant.

13. The system of claim 12 wherein, when operating in the administrator mode, the handheld electronic device is configured to:
present the inventory as an initial list of beverages;
determine an order in which inventory information is entered by the user; and
sort the initial list of beverages based on the determined order.

14. The system of claim 12 wherein each beverage in the inventory is associated with a par value.

15. The system of claim 12 wherein, when operating in the administrator mode, the handheld electronic device is configured to generate a user interface identifying all beverages in the inventory whose stock count is at or below the beverage's associated par value.

16. The system of claim 1 wherein a subset of the first information is retrieved from a third-party beverage directory.

17. The system of claim 1 wherein the storage component is further configured to store third information comprising, for each handheld electronic device in the plurality of handheld electronic devices, a unique identifier identifying the handheld electronic device and an association between the unique identifier and a restaurant identifier, the association identifying a restaurant in the plurality of restaurants where the handheld electronic device is currently deployed.

18. The system of claim 1 wherein the plurality of beverages includes wines, spirits, or beers.

19. A method comprising:
storing, by a computer system, first information pertaining to a plurality of beverages, the first information including, for each beverage, information assets associated with the beverage;
storing, by the computer system, second information pertaining to a plurality of restaurants, the second information including, for each restaurant, a list of beverages from the plurality of beverages that are offered for sale by the restaurant; and
transmitting, by the computer system, at least a portion of the first information and at least a portion of the second information to a plurality of handheld electronic devices used by customers at the plurality of restaurants, the transmitted portions enabling a customer dining at a restaurant to view, via the customer's handheld electronic device, the list of beverages offered for sale by the restaurant and the information assets associated with each beverage.

20. A non-transitory computer readable storage medium having stored thereon program code executable by a processor, the program code comprising:
code that causes the processor to store first information pertaining to a plurality of beverages, the first information including, for each beverage, information assets associated with the beverage;
code that causes the processor to store second information pertaining to a plurality of restaurants, the second information including, for each restaurant, a list of beverages from the plurality of beverages that are offered for sale by the restaurant; and
code that causes the processor to transmit at least a portion of the first information and at least a portion of the second information to a plurality of handheld electronic devices used by customers at the plurality of restaurants, the transmitted portions enabling a customer dining at a restaurant to view, via the customer's handheld electronic device, the list of beverages offered for sale by the restaurant and the information assets associated with each beverage.
